(19) United States
(12) Patent Application Publication
(10) Pub. No.: US 2009/0089789 A1
(43) Pub. Date: Apr. 2, 2009

(54) Method to allocate inter-dependent resources by a set of participants

(75) Inventors: Boi Faltings, Preverenges (CH); Thomas Leaute, La tour de Peilz (CH); Adrian Petcu, Chavannes (CH)

Correspondence Address: HARNESS, DICKEY & PIERCE, P.L.C., P.O. BOX 8910, RESTON, VA, 20195, US

(73) Assignee: Ecole Polytechnique Federale de Lausanne (EPFL)

(21) Appl. No.: 11/905,423

(22) Filed: Oct. 1, 2007

(51) Int. Cl. G06F 9/50

(52) U.S. Cl. 718/104

(57) ABSTRACT

The object of the present invention is a method that allows a group of independent participants to coordinate decisions with respect to the allocation of interdependent resources, while maintaining certain privacy guarantees.

The present invention proposes a method to allocate inter-dependent resources by a set of at least three participants, this method comprising the steps of:
a. receiving by a first participant a request for a first resource by a third participant, and agreeing between the first participant and the third participant on at least one of a pair of allocation/non-allocation keys for the first resource, the allocation key being related to the allocation of the resource and the non-allocation key being related to the non-allocation of the resource,
b. receiving by a second participant a request for a second resource by the third participant, and agreeing between the second participant and the third participant on at least one of a pair of allocation/non-allocation keys for the second resource, the allocation key being related to the allocation of the resource and the non-allocation key being related to the non-allocation of the resource,
c. the third participant defining at least a first preference value defining his interest in a first combination of allocation or non-allocation of the first and second resources,
d. the third participant obfuscating said first preference value using the two keys corresponding to the first combination of allocation and non-allocation of the first and second resources,
e. transmitting the first obfuscated value directly or indirectly to the second participant,
f. de-obfuscating by the second participant the received preference value using the corresponding allocation/non-allocation keys.

### 1 INTRODUCTION AND PRIOR ART

The object of the present invention is a method that allows a group of independent participants to coordinate decisions with respect to the allocation of interdependent resources, while maintaining certain privacy guarantees.

There are many cases where resources, in particular infrastructure resources, need to be shared among multiple self-interested parties. For example, airlines share the capacity of airports, shipping companies share the capacity of storage facilities at ports, oil and gas companies share pipelines, and communications companies share radio spectrum and transmitters. The design and operation of such resources must include devices for controlling the access to ensure safe and efficient operation.

In other cases, access to resources might have to be coordinated among multiple agents. For example, participants might want to set up meetings in such a way that each of the participant's time resources is allocated to at most one meeting. Similarly, in commercial procurement, different departments may consider buying from the same supplier to obtain additional discounts or other advantages. Here, the different orders are resources that need to be allocated to unique suppliers in a coordinated fashion. Conversely, a supplier might have capacity limitations and only be able to deliver one of the orders it is bidding for. In this case, supplier capacity is the resource that needs to be allocated to a unique buyer.

Commonly, such access control devices receive requests for access to each resource and perform an optimization to decide on the most efficient way to allocate the resource among the requests. Often, there are dependencies between different resources, for example:

airlines need to obtain corresponding slots for take-offs and landings;

communication companies have preferences for the same or different frequencies at neighbouring transmitters;

oil companies need to coordinate the use of pipelines and storage facilities;

meetings need to be held at the same time for all participants;

suppliers deliver items in bundles and need to be allocated the orders for all elements of any given bundle.

Currently, such dependencies require allocation decisions to be made by centers that decide on the allocation of multiple resources after receiving information on the dependencies of resource requests from the interested parties. Similar situations occur in supply chains, where there may be dependencies between different suppliers or suppliers may not be able to fulfill all orders due to limited capacity.

However, the dependencies among resource requests are often valuable commercial information, for example:

in airport slot allocation, they represent the routes that airlines want to fly, which are essential to the strategies of competitors;

in communications, they show the capacities and actual usage of other operators, which are again valuable strategic information for competitors;

in sharing pipelines and storage facilities, they give information about available supply which is essential to commodity markets.

in supply chains, commercial conditions must be kept secret from competitors.

Thus, participants are typically unwilling to supply this information to a central device where its privacy cannot be guaranteed.

In this invention, we provide a method where optimization can be carried out without a center and without revealing preferences to other parties. It is based on exchanges of messages between devices managing individual resources and the interested parties.

Earlier methods for coordination while maintaining privacy were based on secure multiparty computation using public-key encryption schemes. These schemes lead to extremely high computational complexity and have therefore never been implemented for problems of practically interesting size. This complexity comes from the fact that they rely on cooperative decryption involving all parties in the process.

### 2 INVENTIVE CONCEPT

This section briefly describes the invention and the associated figures.

### 2.1 Brief Descriptio of the Invention

The object of the present invention is a method whereby the agents can obtain the optimal joint decision while keeping the information about their preferences almost completely private. The method consists of a distributed optimization protocol where agents exchange messages that encode their preferences. By the structure of the method, the information can be encrypted so that agents only find out about the aggregated result of other agents' preferences, protecting agents' specific preferences. They also do not find out what other agents are present in the solving process, beyond those that they have constraints with. Thus, the method preserves the required privacy in each of the applications described in more detail below:

In meeting scheduling, agents only find out about the aggregated preferences of unknown subsets of other agents for each possible meeting time, but they do not find out what other agents have meetings together nor what a specific agent's preferences for a meeting are.

In airport slot allocation, airlines only find out about the maximal preference of an unknown subset of other airlines, but not who these airlines are, what the specific preferences of some airline are, nor what airlines are planning to operate what flights. Airports find out what airlines are interested in a slot and the range of prices they are willing to pay under different conditions, but not what these other conditions are nor at what airport they apply. These are exactly the privacy guarantees required in this problem.

In the procurement example, suppliers do not find out anything about discounts or constraints of other suppliers, nor about the actual prices quoted by other suppliers. Buyers find out what suppliers are offering to supply an item and the range of prices they are offering under different conditions, but not what these other conditions are nor what other suppliers they depend on.

The present invention proposes a method to allocate inter-dependent resources by a set of at least three participants, this method comprising the steps of:
a. receiving by a first participant a request for a first resource by a third participant, and agreeing between the first participant and the third participant on at least one of a pair of allocation/non-allocation keys for the first resource, the allocation key being related to the allocation of the resource and the non-allocation key being related to the non-allocation of the resource,
b. receiving by a second participant a request for a second resource by the third participant, and agreeing between the second participant and the third participant on at least one of a pair of allocation/non-allocation keys for the second resource, the allocation key being related to the allocation of the resource and the non-allocation key being related to the non-allocation of the resource,
c. the third participant defining at least a first preference value defining his interest in a first combination of allocation or non-allocation of the first and second resources,
d. the third participant obfuscating said first preference value using the two keys corresponding to the first combination of allocation and non-allocation of the first and second resources,
e. transmitting the first obfuscated value directly or indirectly to the second participant,
f. de-obfuscating by the second participant the received preference value using the corresponding allocation/non-allocation keys.

In contrast to prior art, the present invention can use symmetric cryptography where decryption can be carried out locally and privacy is achieved by the fact that computation is distributed. With respect to schemes based on secure multiparty computation, slightly more information is revealed, but in many applications this information would become known anyway. Furthermore, the present invention does not rely on public-key cryptography and thus provides stronger security guarantees.

### 2.2 BRIEF DESCRIPTION OF THE FIGURES

The present invention will be better understood thanks to the attached figures in which:

FIG. 1a illustrates a combinatorial auction involving two airlines interested in the combination of two slots managed by two airports,

FIG. 1b illustrates an example of coupled auctions,

FIG. 2 illustrates a meeting scheduling problem,

FIG. 3 illustrates a combinational auction problem,

FIG. 4 illustrates a constraint graph corresponding to FIG. 1b

FIG. 5 illustrates one possible pseudo-tree obtained from the meta-constraint graph in FIG. 1b,

FIG. 6 illustrates one possible pseudo-tree corresponding to FIG. 5 and

FIG. 7 illustrate an algorithm to build a DFS tree.

### 3 DETAILED DESCRIPTION OF THE INVENTION

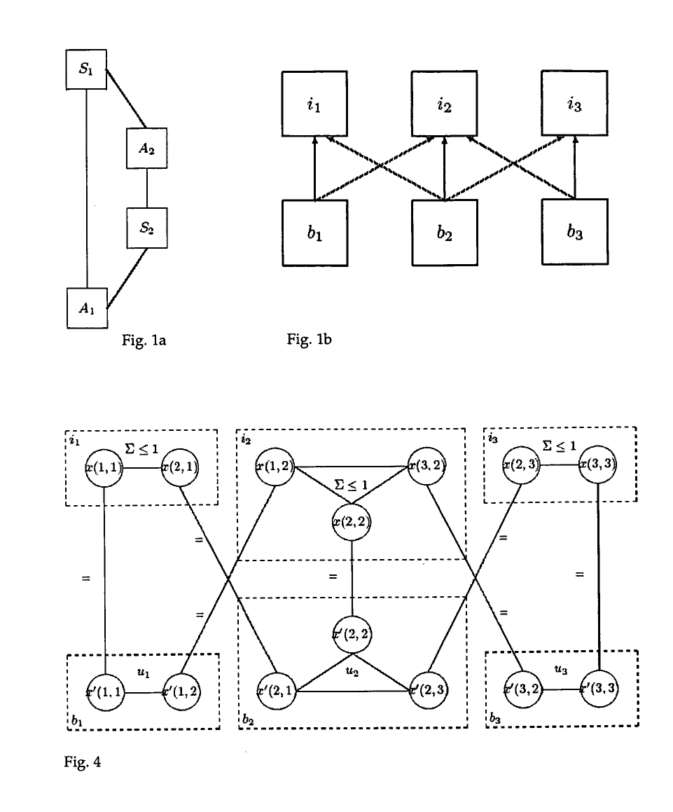

Consider the example presented in FIG. 1a, in which the first and second participants are airports offering each one takeoff/landing slot (referred to as S₁ and S₂), and the third participant is an airline A₁ interested in the combination of the two slots. FIG. 1 also shows a fourth participant, airline A₂, which is also interested in the combination of the two same slots.

In Steps a and b of the method, airline A₁ sends one request to each airport, announcing its interest in slots S₁ and S₂. For each slot Sᵢ, airline A₁ and the corresponding airport then agree on at least one of a pair of keys, the keys being secret random numbers (rᵢ, r′ᵢ) that will be used to obfuscate the airline's preference values related to the allocation/non-allocation of the slot. In our particular example:

Airline A₁ and the airport managing slot S₁ agree on two random numbers:

r₁=12345 corresponding to the non-allocation of S₁ to A₁;

r′₁=23456 corresponding to the allocation of S₁ to A₁;

Airline A₁ and the airport managing slot S₂ agree on two random numbers:

r₂=34567 corresponding to the non-allocation of S₂ to A₁;

r′₂=56789 corresponding to the allocation of S₂ to A₁.

In Step c, airline A₁ defines at least one among a set of four preference values describing its interest in combinations of allocations/non-allocations of the two slots. Table 1 illustrates four possible such preference values, corresponding to the case when the airline assigns a preference value of 5 to being assigned only slot S₁, of 2 for only slot S₂, and of 11 for combination of the two.

TABLE 1
Possible preference values for airline A₁ describing its interest in
combinations of allocations/non-allocations of slots S₁ and S₂.
[Sᵢ, A₁] = 0 and [Sᵢ, A₁] = 1 denote respectively
the non-allocation and the allocation of slot Sᵢ to airline A₁.

| | [S₂, A₁] = 0 | [S₂, A₁] = 1 |
|---|---|---|
| [S₁, A₁] = 0 | 0 | 2 |
| [S₁, A₁] = 1 | 5 | 11 |

Step d: obfuscating step. One or more of the airline's preference values in Table 1 are meant to be sent to the two airports in charge of slots S₁ and S₂; however, as will be illustrated later, the messages containing these preference values will possibly be relayed by third-party participants, who should not be able to read these preferences in clear text. In the particular example of FIG. 1a, the messages will be relayed by airline A₂, which is a competitor of airline A₁ for the allocation of the two slots. In this case, obfuscating airline A₁'s preference values guarantees that these preferences are not revealed to a competitor. Airline A₁ therefore uses the secret keys agreed upon with the two airports in order to obfuscate his preference values, such that only the two airports can de-obfuscate them.

To proceed with this obfuscation, airline A₁ performs the following operations:

Adding the random number r₁ to the row [S₁,A₁]=0;

Adding the random number r′₁ to the row [S₁,A₁]=1;

Adding the random number r₂ to the column [S₂,A₁]=0;

Adding the random number r′₂ to the column [S₂,A₁]=1.

The preference values resulting from this obfuscation are presented in Table 2.

TABLE 2
Airline A₁'s obfuscated preference values.

| | [S₂, A₁] = 0 | [S₂, A₁] = 1 |
|---|---|---|
| [S₁, A₁] = 0 | 46912 | 69136 |
| [S₁, A₁] = 1 | 58028 | 80256 |

In the step e, airline A₁ transmits one or more of the obfuscated preference values in Table 2 to the airport in charge of slot S₂. Note that the message containing these preference values might be relayed by third-party participants before it reaches the airport; however, since they are obfuscated, third parties do not have access to them.

De-obfuscation step f: When the airport in charge of slot S₂ eventually receives the obfuscated preference values, it de-obfuscates them using the secret keys (r₂, r′₂) that it agreed on with the airline. The resulting preference values are presented in Table 3.

Note that these preference values are still obfuscated, since the airport does not know the keys (r₁, r′₁) that would be needed to completely de-obfuscate them. However, complete de-obfuscation is not necessary, since computing differences between the columns can be done on the obfuscated values, and still yields the airline's actual marginal preferences with respect to being assigned slot S₂, which is what the airport needs to be able to take a decision. In this example, computing 12347−12345=2 and 23467−23461=6 yields that the marginal preference value for slot S₂ is 2 (if the airline does not get assigned slot S₁ ) or 6 (if it does).

TABLE 3
Airline A₁'s de-obfuscated preference values, after subtracting the keys
(r₂, r′₂) from the columns.

| | [S₂, A₁] = 0 | [S₂, A₁] = 1 |
|---|---|---|
| [S₁, A₁] = 0 | 12345 | 12347 |
| [S₁, A₁] = 1 | 23461 | 23467 |

In a particular embodiment, the method of the invention further comprises the steps of:

transmitting directly or indirectly by the second participant said de-obfuscated first preference value to the first participant,

de-obfuscating by the first participant the received preference value using the corresponding allocation/non-allocation keys.

For the airport in charge of slot S₁ to be able to make a decision on the allocation of this slot, the airport in charge of slot S₂ must forward (directly or indirectly) one or more of the preference values that it received from airline A₁. Note that not all preference values need to be forwarded, since some of them might correspond to sub-optimal assignments of slot S₂. These sub-optimal cases have been removed from Table 3 in Table 4.

TABLE 4
De-obfuscated preference values received by the airport

| | |
|---|---|
| [S₁, A₁] = 0 | 12347 |
| [S₁, A₁] = 1 | 23467 |

in charge of slot S₂. Sub-optimal values are not shown.

Upon reception, the airport in charge of slot S1 is able to de-obfuscate the preference values using its keys (r₁, r′₁), by subtracting the random number r₁ from all preference values corresponding to the non-allocation of the slot to airline A₁, and subtracting r′₁ from those corresponding to the allocation of slot S₁ to airline A₁. The resulting de-obfuscated preference values are presented in Table 5.

TABLE 5
De-obfuscated preference values received by the airport in
charge of slot S₁.

| | |
|---|---|
| [S₁, A₁] = 0 | 2 |
| [S₁, A₁] = 1 | 11 |

In case that more than three participants are involved and in case of indirect transmission of the de-obfuscated first preference value, this method further comprises the steps of:

receiving by a fourth participant said value, aggregating said value with other preference values,

transmitting directly or indirectly by said fourth participant said aggregated value to the first participant.

As illustrated in FIG. 1a, the message transmitted by the airport in charge of slot S₂ to the airport in charge of slot S₁ may be relayed by one or more third parties. In this example, the message transits through a fourth participant, airline A₂, that competes with airline A₁ for the allocation of the two slots.

Rather than simply forward the received message, both the airport in charge of slot S₂ itself (referred to as the second participant) and the fourth participant might modify it by aggregating other preference values. In this example, these other preference values correspond to their preferences with respect to the allocation of the slots.

For instance, the airport in charge of slot S₂ has preference values on the combined allocations/non-allocations of the slot to the two airlines; these preferences correspond to the constraint that the slot cannot be allocated to both airlines simultaneously. This constraint translates to the preference values presented in Table 6. The value of number M is chosen so as to be bigger than any cleartext preference value, but smaller than the obfuscating random numbers. In this example, M=1000.

TABLE 6
Preference values of the airport in charge of slot S₂, corresponding to the
constraint that the slot may not be allocated to more than one airline.

| | [S₂, A₁] = 0 | [S₂, A₁] = 1 |
|---|---|---|
| [S₂, A₂] = 0 | 0 | 0 |
| [S₂, A₂] = 1 | 0 | −M = −1000 |

Aggregating these preference values with airline A₁'s preference values in Table 3 yields the preference values presented in Table 7, at least one of which the airport transmits indirectly to the airport in charge of slot S₁. In this example, the aggregation simply involves subtracting 1000 to all preference values from Table 3 corresponding to the allocation of slot S₂ to both airlines.

TABLE 7
Preference values resulting of the aggregation of the preference values in
Tables 3 and 6.

| | | [S₂, A₁] = 0 | [S₂, A₁] = 1 |
|---|---|---|---|
| [S₂, A₂] = 0 | [S₁, A₁] = 0 | 12345 | 12347 |
| | [S₁, A₁] = 1 | 23461 | 23467 |
| [S₂, A₂] = 1 | [S₁, A₁] = 0 | 12345 | 11347 |
| | [S₁, A₁] = 1 | 23461 | 22467 |

Note that it is not necessary for the airport to transmit all of these preferences, since some of them actually correspond to sub-optimal allocations. Removing the sub-optimal preference values associated with the allocation/non-allocation of slot S₂ to airline A₁ yields Table 8.

TABLE 8
Preference values from Table 7, without the sub-optimal preference
values.

| | | |
|---|---|---|
| [S₂, A₂] = 0 | [S₁, A₁] = 0 | 12347 |
| | [S₁, A₁] = 1 | 23467 |
| [S₂, A₂] = 1 | [S₁, A₁] = 0 | 12345 |
| | [S₁, A₁] = 1 | 23461 |

When it receives these preferences, airline A₂ first aggregates them with its own preference values related to the allocation of the two slots, before transmitting (in this example, directly) the resulting aggregated preference values to the airport in charge of slot S₁. Airline A₂'s own preference values are presented in Table 9.

TABLE 9
Airline A2's preference values with respect to the allocation/non-allocation
of the two slots.

| | [S₁, A₂] = 0 | [S₁, A₂] = 1 |
|---|---|---|
| [S₂, A₂] = 0 | 0 | 4 |
| [S₂, A₂] = 1 | 3 | 9 |

The aggregated preference values derived from Tables 8 and 9 are presented in Table 10. As for the previous aggregation, the process of producing these aggregated preferences involves summing up preference values from the two tables corresponding to the same combinations of allocations/non-allocations of slots.

TABLE 10
Aggregated preference values derived from Tables 8 and 9.

| | | [S₁, A₂] = 0 | [S₁, A₂] = 1 |
|---|---|---|---|
| [S₂, A₂] = 0 | [S₁, A₁] = 0 | 12347 | 12351 |
| | [S₁, A₁] = 1 | 23467 | 23471 |
| [S₂, A₂] = 1 | [S₁, A₁] = 0 | 12348 | 12354 |
| | [S₁, A₁] = 1 | 23464 | 23470 |

It is also not necessary for airline A₂ to transmit all of these preferences, as some of them correspond to sub-optimal allocations of slot S₂. Removing them from Table 10 yields Table 11. When the airport in charge of slot S₁ receives one or more of the preference values in Table 11, it then proceeds as previously in order to de-obfuscate the preferences, by subtracting r₁ (respectively r′₁) from all values corresponding to the non-allocation (respectively the allocation) of slot S₁ to airline A1. This results in the de-obfuscated preference values in Table 12. Note that the preference value of 15 actually corresponds to the disallowed case when slot S₁ is allocated to both airlines simultaneously.

TABLE 11
Preference values from Table 10, without the sub-optimal preferences.

| | [S₁, A₂] = 0 | [S₁, A₂] = 1 |
|---|---|---|
| [S₁, A₁] = 0 | 12348 | 12354 |
| [S₁, A₁] = 1 | 23467 | 23471 |

TABLE 12
De-obfuscated preference values from Table 1

| | [S₁, A₂] = 0 | [S₁, A₂] = 1 |
|---|---|---|
| [S₁, A₁] = 0 | 3 | 9 |
| [S₁, A₁] = 1 | 11 | 15 |

In the present invention, and according to a particular embodiment, the second participant uses the de-obfuscated first preference value to make a decision to allocate or not allocate the second resource to the third participant.

Once the airport in charge of slot S₂ has received and de-obfuscated one or more preference values, it might be able to make a decision to allocate or not allocate the slot to airline A₁.

Consider for instance the preference values presented in Table 3. Comparing the two values in the first row yields that, assuming that slot S₁ is not allocated to airline A₁, it is preferable to allocate slot S₂ to airline A₁ that not to do so, since 12347>12345. In the second row, which corresponds to slot S₁ being allocated to airline A₁, it is also preferable to allocate slot S₂ to airline A₁ (23467>23461). The airport can therefore conclude that, regardless of the allocation of slot S₁, it should allocate slot S₂ to airline A₁.

In the present invention, and according to a particular embodiment, the first participant uses the de-obfuscated received preference value or aggregated preference value to make a decision to allocate or not allocate the first resource to the third participant.

Using the preference values that it received, the airport in charge of slot S₁ can infer the preferable decision to make with respect to the allocation of the slot. In the case of Table 5, comparing the two preference values yields that the optimal decision is to allocate the slot to airline A₁ (11>2). In the case of Table 12, knowing that the preference value of 15 is disallowed since it corresponds to allocating the slot to both airlines simultaneously, the maximum preference value of 11 is reached by deciding to allocate the slot to airline A₁.

In the present method, various ways are used for the aggregation such as the sum, product, minimum or the maximum of the obfuscated first preference value and at least one other preference value. In the example we describe, the aggregation is made by summation of the numbers representing the original preference values, and choosing the maximum in order to find the solution with the best overall utility to the participants. Nevertheless, minor modifications allow the implementation of other aggregation methods such as:

1. for the case where preference values represent costs, the best solution is the one that minimizes the overall cost. In this case, the aggregation is made again by summation of the costs, but then choosing the minimal cost alternatives.

2. for the case where the preference values represent probabilities, the aggregation can be made by multiplication instead of summation, and again by choosing the alternatives with the maximal probability.

3. the trivial case where some preference values correspond to feasible or infeasible combinations of decisions is already dealt with by associating very unfavourable preference values to such infeasible combinations (for example large positive numbers when doing cost minimization as in Point 1), large negative numbers when doing utility maximization, or probability 0 when doing probability maximization like in 2)).

The claimed method further comprises the steps:

transmitting to the second participant by the first participant the decision to allocate/not allocate the first resource to the third participant,

deciding by the second participant whether or not to allocate the second resource to the third participant based on the decision made by the first participant and the received preference values.

First consider the case of the main method, in which the preference values sent by the airport in charge of slot S₂ to the airport in charge of slot S₁ are transmitted without modification. After deciding to allocate slot S₁ to airline A₁, the airport transmits this decision ([S₁,A₁]=1) to the airport in charge of slot S₂, which then decides to also allocate the second slot to airline A₁, based on the row corresponding to [S₁,A₁]=1 in Table 3.

Consider now the case of indirect transmission of the preference values, in which preference values sent by the airport in charge of slot S₂ are transmitted indirectly to the airport in charge of slot S₁, through airline A₂, which aggregates these values with other preference values. In this case, the decisions to allocate slot S₁ to airline A₁ and not to airline A₂ ([S₁,A₁]=1 and [S₁,A₂]=0) are first received by airline A₂.

According to Table 10, the preference values corresponding to these allocations are 23467 if [S₂,A₂]=0, and 23464 if [S₂,A₂]=1. As a consequence, airline A₂ decides that it should not be allocated slot S₂, and sends this decision (along with the decision [S₁,A₁]=1) to the airport in charge of slot S₂.

When receiving these two decisions, the airport looks up the corresponding preference values in Table 7, which are 23461 if [S₂,A₁]=0, and 23467 if [S₂,A₁]=1, and decides accordingly that slot S₂ should be allocated to airline A₁.

According to another embodiment of the invention, the definition of the first preference value by the third participant is based on at least one previous decision to allocate or not allocate a resource to said third participant.

As mentioned in the description of main method, airline A₁ sends a message comprising at least one preference value, but needs not send all of its preference values simultaneously. In particular, it can send preference values as responses to requests from other participants, where the requests take the form of decisions to allocate/not allocate a slot to airline A₁, which replies by sending one or more preference values corresponding to these decisions.

According to another embodiment of the invention, the main method further comprises the agreement between the first participant and the third participant on a codename defining the allocation/non-allocation of the first resource to the third participant.

Preference values are not the only information that airline A₁ could be willing to hide from possible competitors through which its messages might be relayed. It could desire to also keep its requests for time slots secret, because they are part of its business strategy.

As indicated in Table 2, the obfuscated preference values that airline A₁ transmits refer to combinations of allocations/non-allocations of slots, referred to by the [Sᵢ,A₁] identifiers. In particular, the presence of the [S₁,A₁] identifier in clear text in messages sent by the airline could reveal the existence of its request for slot S₁ to a competitor, if the messages are relayed by this competitor.

The workaround in this case is for the airport in charge of a slot S₁ to agree with airline A₁ on a secret codename used in lieu and place of the [S₁,A₁] identifier, in order to obfuscate the existence of airline A₁'s request for slot S₁.

According to another embodiment of the invention, the main method further comprises computing by the first participant a payment which is requested from the third participant for the allocation of the first resource.

In our payment protocol, each resource owner requests from the recipient of its resource to specify its preference values for the non-allocation of the resource.

In the example from FIG. 1, both slots are allocated to A₁. The process thus begins with the airport controlling the slot S₁ requesting from airline A₁ to specify its preference value for the non-allocation of slot S₁ to A₁. The total aggregated utility for S₁ resulting from the utility propagation and aggregation phase is u(S₁)=11. A₁ replies with its preference value for not obtaining slot S₁, but obtaining slot S₂ as was determined to be the case in the optimal solution. This preference value is in this example equal to 2, as seen in Table 1. This preference value is sent to S₂ (in the obfuscated form 12347, as in Table 3), who updates its view of the utility it can provide to its subtree: u(S₂)=12347. S₂ aggregates the received preference value with its own preference value for this context (which is 0 in this case). S₂ further sends the aggregated preference value to A₂, which again aggregates it with its own preference value for this context (i.e. when A₂ gets nothing, which is 0, as seen in Table 9). Finally, the preference value of A₁ not getting S₁ but getting S₂ reaches S₁, and it equals 2 (after de-obfuscation). Therefore, S₁ will charge from A₁ a payment of u(S₁)−2=11−2=9 for allocating S₁ to A₁.

In case that a payment is considered, the claimed method further comprises computing by the second participant a payment which is requested from the third participant for the allocation of the second resource.

Similar to S₁, S₂ proceeds to compute the payment it should claim from A₁ for allocating it the slot S₂. Specifically, S₂ requests from airline A₁ to specify its preference value for the case where neither slot S₁ or slot S₂ are allocated to A₁. A₁ naturally replies with the value 0, obfuscated as 12345, and thus S₂ computes a payment of u(S₂)−12345=2 that it requests from A₁ for allocating it the slot S₂. Notice that the sum of payments that A₁ makes is 9+2, which equals its valuation for the bundle of items {S₁, S₂} (see Table 1).

In order to facilitate the main method of the present invention, it is desirable to establish a hierarchy among the participants in an anonymous fashion, this establishment comprising the following steps:

1. defining, for each participant, a participant identifier: this step is easily implemented by assigning for example a number from 0 to n−1 to each participant, where n is the number of participants. In the example from FIG. 1a, identifiers can be numbers from 0 to 3 as follows: S₁=0, S₂=1, A₁=2, A₂=3.

2. choosing among the participants a preliminary leader: any method can be used to choose one of the participants as a preliminary leader, for example by choosing the participant with the highest ID. In our example, this is A₂, whose ID is 3.

3. constructing a Depth-First Search (DFS) arrangement of all the participants, starting from the chosen preliminary leader and using a depth-first traversal method: to this end, any existing DFS construction protocol can be used, such as the one described below. A possible DFS obtained from such a protocol would be the chain A₂−S₂−A₁−S₁.

4. executing by the participants, in depth-first order according to the depth-first arrangement from Point 3, an encrypted computation that results in each participant computing a function that evaluates to true if the participant is the chosen leader, and to false otherwise. A possible implementation is as follows: each participant chooses a random number. The participants establish a secure cryptographic circuit for adding up the random numbers modulo n (n=4 is the number of participants). The computation performed by the cryptographic circuit tells each participant whether the sum of the random numbers modulo n equals its ID or not. If it does, then the participant knows that it was chosen as the leader, otherwise not. Assume in our example that the participants have chosen as random numbers 1, 2, 1, 0. This yields the sum equal to 4, which modulo 4 means that the chosen ID is 0, i.e. S₁ has been chosen as leader. Again, it is important to note that this is only known to S₁.

5. propagating a token by the participants, said token propagation being initiated by the leader with the purpose of visiting all participants: this step is further described below.

According to one embodiment of the invention, the propagation of the token is achieved through the following steps. Once the leader has been elected, it starts the propagation of the token which results in visiting each participant in the problem. Assume that S₁ has been elected as the leader. S₁ has two neighbors: A₁ and A₂. S₁ chooses (in any fashion) one of its neighbors, for example A₂. It then sends a token to A₂ and marks it as its child. A₂ receives the token, and since this is the first token it has received, it marks the sender (S₁) as its parent. Note that the only information available to A₂ after receiving this token is that S₁ is its parent. A₂ for example does not know if there are any other participants above S₁, in other subtrees of S₁, nor how many other participants have already been visited, or their identities.

A₂ has another unvisited neighbor, S₂. A₂ sends a token to S₂ and marks it as its child. S₂ receives the token, and since this is the first token it has received, it marks the sender (A₂) as its parent. S₂ has another unvisited neighbor, A₁. S₂ sends a token to A₁ and marks it as its child. A₁ receives the token, and since this is the first token it has received, it marks the sender (S₂) as its parent. Now, A₁ is a neighbor of S₁. S₁ has already been visited (it is in fact the leader, thus the first participant to have been visited), but this is not known to A₁. Therefore, as far as A₁ knows, S₁ can be its child, so it sends the token to S₁. Nevertheless, S₁ does know that it was already visited, and it replies with a special token that can be interpreted as “already-visited”. This informs A₁ that S₁ was already visited, and it is therefore an ancestor to A₁, and not a child.

After receiving the reply from S₁, A₁ sends back the token to its parent, S₂. Note that S₂ does not gain any knowledge from this token as to whether there were any other participants visited below A₁, how many of them, or their identities. In particular, S₂ also does not find at this point about the fact that A₁ and S₁ are neighbors. S₂ then returns the token to its parent A₂, which returns it to S₁.

Most importantly, notice that during this process, no participant discovers anything beyond the neighboring relations it already knew before running the process, and ancestor-descendant relationships it has with its direct neighbors.

This is important because it prevents for example the competing airlines A₁ and A₂ from finding out about their mutual interest in the same pair of slots, or even about their being present in the problem at all.

In a particular embodiment of the invention, decisions on the allocation/non-allocation of resources are made so as to eliminate the need for announcing the optimal allocations to the participants lower in the hierarchy. The enabler to this procedure is that the leading participant (the root of the hierarchy) receives from all the other participants (aggregated) preference values, which, once aggregated, lead to the root being able to find its optimal decision. The first iteration of this procedure is like described in the main method of the invention: one of the participants takes the role of the root, preference values are transmitted and aggregated by the participants, until the root receives all required (aggregated) preference values. The root then chooses the decision that corresponds to the best aggregated preference value, and stores it as its optimal decision, but does not announce it to other participants.

Subsequently, the participants take turns in being the root. For each iteration, a new participant becomes root, and gets to choose its optimal decision.

The participants who have already been root and thus have made their optimal decisions assume these optimal decisions are “frozen” while recomputing the aggregations in these subsequent runs. This ensures that in each subsequent run, the same optimal solution to the whole allocation problem is recomputed as in the first run. The advantage of this procedure is that the need for explicitly communicating decisions is eliminated, and each participant can make its decisions without necessarily knowing what other participants have decided.

In the example from FIG. 1a, assume that S₁ has been chosen to be the root in the first round. Then in the first run, the propagation and aggregation of preference values proceeds as described above, and S₁ makes its decision to allocate S₁ to A₁. Subsequently, every other participant takes the leading role, and a new run of the algorithm is executed. In each of these runs, S₁ will only consider the case when it allocates itself to A₁ while propagating and aggregating preference values. This ensures that the participant at the top obtains a coherent view of the aggregated preference values, and that the assignment it determines to be optimal is consistent with the value that would have otherwise been determined in the first round.

The above examples are only given to illustrate the method, which is obviously widely applicable to scenarios where multiple agents need to make coordinated and possibly optimal decisions while preserving privacy of their preferences and constraints, whether connected with payments in auctions or not. The method can be applied wherever a joint decision is required, such as in combinatorial auctions, sharing joint resources, joint scheduling and planning, and synchronizing data.

Each agent has to take one or more decisions, identified by decision variables that have to take one out of a set of possible values. Certain groups of decisions may be linked by constraints, meaning that only certain combinations are feasible. Furthermore, agents can have preferences, expressed as numerical utilities, on individual or combinations of decisions.

The method that is the object of this invention allows agents to combine their preferences regarding a certain decision in an obfuscated or encrypted form such that they can be decrypted only by the agent that has to make this decision. In this way, the privacy of an agent's preferences is entirely protected.

The method of this invention finds a value for each decision variable such that as many constraints between them are satisfied as possible, and the sum of the utilities expressed by the individual agents is as large as possible. The decisions are found by a sequence of message exchanges between agents.

Another object of this invention is to use codenames for decisions and decision values as well as anonymous leader election and DFS construction protocols that ensure that no agent can determine any of the following information:

1. The identity of other agents in the problem except for those that control decisions that it has a preference for or that directly constrain its own decisions;

2. The existence of decision variables other than those that control decisions that it has a preference for or that directly constrain its own decisions;

3. Which other agents have preferences regarding what combinations of decision variables;

4. The value of the preference that another agent has in one or a combination of decision variables.

In contrast to earlier methods, privacy is achieved without necessarily requiring cryptographic methods, and in particular without cooperative encryption/decryption. This means that agents can decrypt the information they need to know without invoking other agents. This feature in particular enables the privacy guarantees on the existence of other agents in the problem which cannot be given in other methods.

In problems where payments must also be decided, in particular for auctions and reverse auctions, the method of this invention also shows protocols for determining the payments that each agent should make or receive.

### 4 EXAMPLES OF APPLICATIONS

The invention can be applied to a variety of scenarios, such as the following: scheduling meetings between agents, combinatorial auctions consisting of several individual auctions, allocating landing slots among airlines, sharing transmission time on a transmitting facility, etc. The following sections provide more details about these scenarios.

4.1 Multiagent Meeting Scheduling

Consider a large organization with dozens of departments, spread across dozens of sites, and employing tens of thousands of people. Employees from different sites or departments (these are the agents A) have to setup hundreds/thousands of meetings. Due to privacy concerns among different departments, centralized problem solving is not desirable. The organization as a whole desires to minimize the cost of the whole process (alternatively, maximize the sum of the individual utilities of each agent).

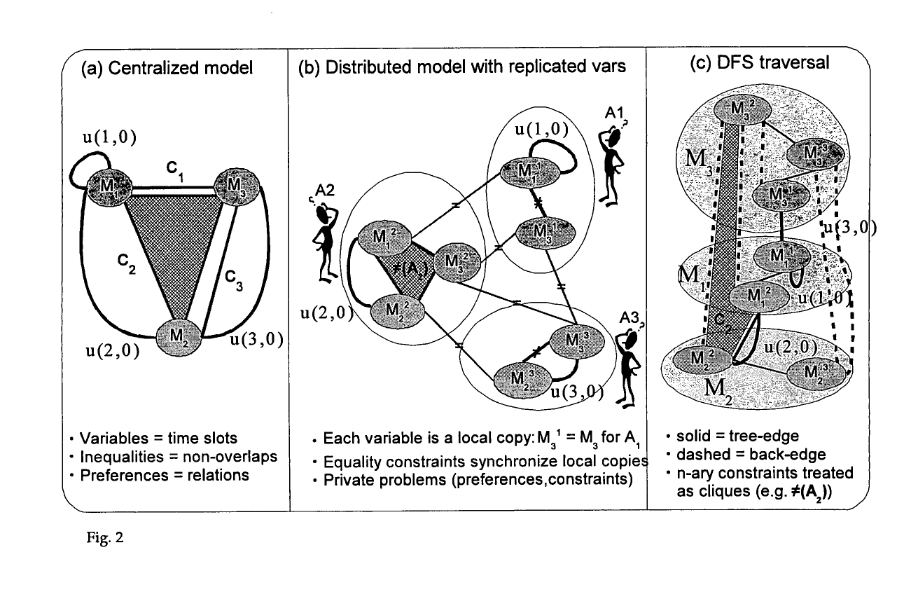

Each agent has a local scheduling problem composed of its own meetings; inter-agent constraints model the interdependencies between local schedules. FIG. 2 shows an example where 3 agents want to find the optimal schedule for 3 meetings. A simple, centralized model for this problem is shown in FIG. 2(a): each meeting corresponds to a variable which models the time slot allocated to the meeting; the values for each variable are the possible time slots for the corresponding meeting. In this model, the agents can express preferences by placing constraints/relations directly on the corresponding variables.

However, for all the reasons enumerated above, we wish to allow the agents to find the optimal schedule in a distributed fashion, and the centralized model from FIG. 2(a) is not well suited for this purpose. We introduce the following distributed model of the meeting scheduling problem. Each agent has a set of variables Xᵢε X which represent the meetings it participates in (e.g. A₂-M₁ is A₂'s variable representing meeting M₁). Local all-different constraints (hard constraints c(i, 0)ε C) between an agent's variables ensure that it does not participate in several meetings at the same time. Inter-agent equality constraints between local variables corresponding to the same meeting model the requirement of global agreement. These are also hard constraints cᵢ,εC.

Agents can also specify their preferences via utility relations u(i,j) ε R on their local variables. For example, A₁ can specify its preference for having meeting M₁ later in the day by using the relation u(1, 0) to assign low utilities to morning time slots, and high utilities to afternoon time slots. Similarly, if A₂ prefers holding meeting M₂ after meeting M₁, then it can use the relation u(2,0) to assign high utilities to all satisfactory combinations of timeslots for M₁ and M₂, and low utilities to all other combinations. For example, (M₁=9 AM, M₂=11 AM) gets value 10, and (M₁=9 AM, M₂=8 AM) gets value 2. This model of a meeting scheduling problem as a DCOP corresponds to the model in [1].

4.2 Combinatorial Auctions

Auctions are a popular way to allocate resources or tasks to agents in a multiagent system. Essentially, bidders express bids for obtaining a good (getting a task in reverse auctions). Usually, the highest bidder (lowest one in reverse auctions) gets the good (task in reverse auctions), for a price that is either his bid (first price auctions) or the second highest bid (second price, or Vickrey auctions).

Combinatorial auctions (CA) are much more expressive because they allow bidders to express bids on bundles of goods (or tasks), thus being more useful when goods are complementary or substitutable (the valuation for the bundle does not equal the sum of valuations of individual goods). There are many applications of CAs in multiagent systems like resource allocation, task allocation, robot coordination, etc.

Formally, a combinatorial auction can be defined as follows.

Definition 1(Combinatorial Auction (CA)) A combinatorial auction (CA) is a tuple <A,I,B> such that:

A={A₁, . . . , Aₖ} is a set of bidding agents;

I={i₁, . . . , iₙ} is a set of (indivisible) items (goods);

B={b₁, . . . , bₖ} is a set of bids; a bid b(k, i) expressed by an agent Aᵢ is a tuple <Aᵢ, G(k, i), v(k, i)>, where v(k, i) is the valuation agent Aᵢ has for the bundle of goods G(k, i) ε I; when Aᵢ does not obtain the whole set G(k, i), then v(k, i)=0.

A feasible allocation is a mapping S: B→{true, false} that assigns true or false to all bids b(k, i) (where true means that agent Aᵢ wins its bid b(k,i)), such that ∀b(k,i),b(l,m), if ∃iⱼ ε I s.t. iⱼ ε b(k,i) Λ iⱼ ε b(l,m), then at least one of b(k, i), b(l, m) is assigned false. In words, no two bids that share a good can both win at the same time (because of indivisible goods). The value of an allocation S is

$$val ( S ) = {\sum }_{b ( k , i ) ∈ Bs \cdot t \cdot S ( b ( k , i ) ) = true} ( v ( k , i ) )$$

Finding the optimal allocation S*=argmaxS(val(S)) is NP-hard and inapproximable.

FIG. 1b shows an example consisting of three items i₁, i₂, i₃ for sale in separate, parallel, sealed-bid auctions, and three bidders b₁, b₂, b₃ interested in acquiring some or all of the items. In this example, bidder b₁, bids for items i₁ and i₂, bidder b₂ for all three items, and b₃ for i₂ and i₃.

4.3 Airport Slot Allocation

In this example, airports allocate takeoff and landing slots to different airlines and need to coordinate these allocations so that airlines have corresponding slots for their flights. Here, the airports and airlines are agents; airports decide which airlines to allocate available slots to, while airlines decide which flights to operate. These decisions must be coordinated so that for every flight the airline has the required slots for its takeoffs and landings.

In airport slot allocation, the routes and times that an airline is planning to fly, as evident from its interest in certain slot combinations, is valuable commercial information that must not be revealed to its competitors. This example is a direct application of the combinatorial auction problem described in Section 4.2, where the auctioneers are the airports, and the bidders are the airlines. An airport has possibly many slots to offer (similarly to an auctioneer who has many items for sale), and an airline requests possibly several slots (similarly to a bidder who bids in several auctions).

### 5 APPLICATION TO COMBINATORIAL AUCTIONS

As seen in the previous sections, the invention applies to a broad range of scenarios; however, we choose to describe it on the example of combinatorial auctions. A skilled practitioner will see how the method applies to other scenarios similar to the examples outlined above.

In order to be able to solve the winner determination problem, we will first model the CA problem into an optimization problem. The following two sections present two models which provide different levels of privacy for the agents. Section 5.1 presents a centralized model, which assumes a center that collects the bids and solves the problem in a centralized fashion. The privacy loss to the center is complete. Section 5.2 presents a distributed model which does not assume the existence of a center, and preserves privacy to a great extent.

5.1 Centralized Model for CAs

This centralized model is a simple model where each item is associated with a variable which models the winner of the item. Bids from the agents are modeled as relations between the items present in the bid. A graph is thus formed with nodes being the variables, and (hyper)edges being the bids.

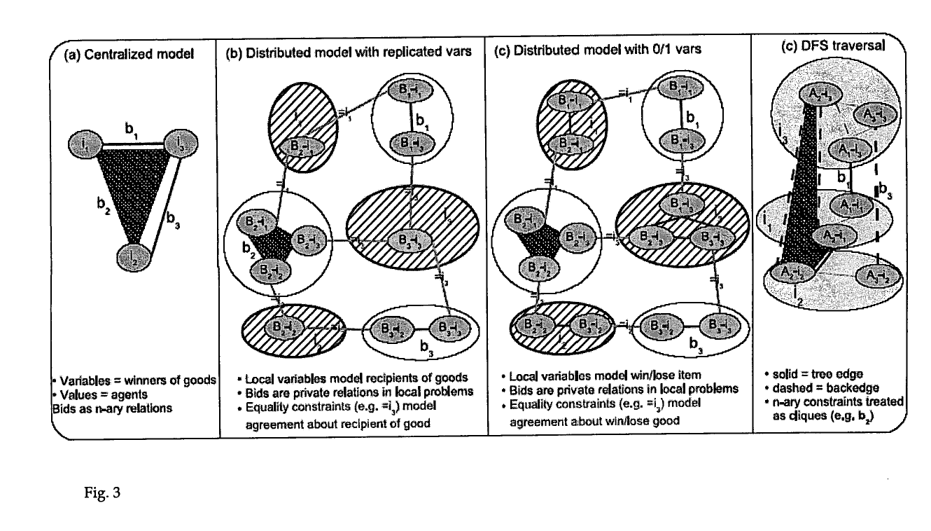

FIG. 3(a) shows the centralized model that corresponds to the auction problem from FIG. 1(b).

This model gives less privacy guarantees since agents directly express their preferences on the allocation of the items. Plus, the center which collects the bids has full access to these bids.

5.2 Distributed Model for CAs

This section presents a decentralized model of the CA problem which allows the agents to execute a distributed protocol to solve the problem, and additionally provides better privacy guarantees.

Similar to the meeting scheduling example, one can cast the CA problem to a similar model. The variables express which bidder is the winner of each item, and each agent has a local problem composed of its items of interest, connected by a relation which expresses its bid. The resulting model of the problem from FIG. 1(b) is shown in FIG. 3(b).

This model eliminates the need for a center to collect the bids, and allows the agents to execute a distributed optimization protocol for deciding the allocation. It also provides some privacy guarantees, in that agents which do not share any item of common interest do not have to learn about each other.

However, this model still leaks some private information because of the way variables belonging to different agents are connected with equality constraints. Through these constraints, every agent interested in an item eventually finds out what other agents are interested in that item, and which one of them is the winner of the item. Notice that this is not a problem in the case of meeting scheduling, where it is natural that all participants in a meeting know about each other, and also must know the allocated time for the meeting.

We present in the following a refined model which builds on the previous one, and which fixes these problems. To each valid bidder-item pair (bᵢ, iⱼ) corresponds a binary variable x(i, j) ε {0,1}, so that x(i,j)=1 if and only if iⱼ is sold to bᵢ. Two types of constraints exist on these variables:

1. Each item can only be sold to at most one bidder, which translates to the following constraint, for each item iⱼ:

Σᵢx(i,j)≦1

2. Each bidder bᵢ has a utility function uᵢ that creates interactions between auctions: for instance b₁ might be interested in getting only i₁ or i₂, but not both; or b₂ might be willing to pay for all three items more than the sum of its bids for each single item.

For our example, this model corresponds to the one in FIG. 3(c).

An important remark is that full knowledge about constraints of type 1 is only available to their corresponding auctioneers, and must be kept hidden from bidders, who would otherwise know how many other bidders are competing for the items, and possibly their identities. On the contrary, information about utility functions uᵢ belong to their corresponding bidders, whose interest is in hiding this information from other bidders, and even from auctioneers, whenever possible.

In order to keep these constraints and preferences private, the DCOP encoding involves two copies x(i,j) and x′(i,j) of the same variable; variable x(i,j) is owned by the auctioneer for item iⱼ, while variable x′(ij) is owned by bidder bᵢ. Private constraints hence become proper to their corresponding agents, as illustrated in the constraint graph in FIG. 4. The only inter-agent constraints are the constraints x(i,j)=x′(i,j).

As will be shown later, the use of binary variables in this encoding also guarantees that bidders who loose an auction do not learn the identity of the winner: they only learn whether they won the auction (x′(i,j)=1), or they lost it (x′(i,j)=0).

5.2.1 Constructing the Distributed Combinatorial Auction Problem

Concretely, the process of constructing the Distributed Combinatorial Auction Problem proceeds as follows:

1. All buyers announce their interest to the sellers of the respective goods.

2. Each buyer bₖ interested in an item i₁ will create internally a variable x′(k,l) which models it being awarded the item or not. Buyer bₖ creates such a variable for each item it is interested in. It then expresses internally its utility function on the packages of interest as a function of its internal variables.

3. Each seller of any item i₁, upon receiving a buyer bₖ's expression of interest in its item, will create internally a variable x(k,l) that models the decision of awarding the item to bₖ. The seller creates such a variable for each buyer who expressed interest in its item. It then models internally the fact that it can award the item to at most one buyer as a constraint on its internal variables.

4. Agreement among agents about the allocation of items to buyers is modeled by having each buyer-seller pair agree on the values of their corresponding variables. This is enforced with equality constraints between corresponding variables; these constraints are depicted as edges in the graph in FIG. 4. For example, x′(k,l)=x(k,l) models that both buyer bₖ and the seller of item i₁ will agree on whether i₁ will be sold to bₖ or not. This point is crucial as it ensures a consistent allocation (each item is sold to at most one buyer).

Notice that in this model, each variable x′(k,l) of a seller agent of an item i₁ is connected with exactly one corresponding variable x(k,l) of a buyer agent bₖ; we call these variables peers.

5.2.2 Extension to Multiple-Item Auctions

In the model previously described, we implicitly assumed that each auctioneer owns only one item put for auction. This assumption is made for the sake of simplicity, and will hold throughout the following sections.

It is however easy to release this assumption, and to allow one auctioneer to put for sale more than one item, possibly imposing coupling preferences on the sales. For instance, in the example in FIG. 4, items i₁ and i₂ could be sold by the same auctioneer, which could impose the additional constraint that one item cannot be sold if the other remains unsold. More complex constraints could involve offering a discount if both items are sold to the same bidder. In the constraint graph in FIG. 4, this would translate to additional constraints between the blocks of variables corresponding to items i₁ and i₂, which would then both be owned by the same auctioneer.

5.3 Adaptation of the Model to Reverse Auctions

In the previous sections as well as in the following, the invention is illustrated on an example of combinatorial auctions. However, it also seamlessly applies to reverse auctions, as we show in this short section.

In reverse auctions, the goods (or tasks in the case of procurements) are offered by the bidders, which can hence be called suppliers. The constraint graph would then be exactly the same as the one for auctions in FIG. 4, except that, since the aim is no longer to assign the task to the bidder offering the highest bid, but rather to the bidder offering the lowest bid, the bidders' private utilities uᵢ would be encoded with negative numbers. This way, maximizing the total, aggregated sum of negative bids corresponds to minimizing the total, aggregated sum of bids.

As mentioned in the previous section, the resulting model would be founded upon the assumption that each seller only puts one task for auction. This assumption can be removed by adding constraints coupling different tasks, expressing one auctioneer's coupled preferences with respect to its tasks.

Finally, while it is theoretically possible in an auction for an auctioneer to decide not to sell its item, in reverse auctions, the buyer often does not have the choice of leaving one of its tasks unassigned. This can be modeled by replacing Σ≦1 constraints by Σ=1 constraints.

5.4 DFS Trees

Once the problem graph is constructed (Section 5.2.1), a DFS traversal of the problem graph is initiated. This phase has the goal to generate a depth-first traversal (DFS) of the problem graph in a distributed manner. This DFS tree is subsequently used as a communication structure for our algorithms: nodes exchange messages with their ancestors and descendants in the DFS tree, but not with any siblings.

Definition 2 (DFS tree) A DFS arrangement of a graph G is a rooted tree with the same nodes and edges as G and the property that adjacent nodes from the original graph fall in the same branch of the tree (e.g. b₂ and i₃ in FIG. 6).

FIG. 6 shows an example of a DFS tree. We distinguish between tree edges, corresponding to parent-child relationships (e.g. i₁-b₂), and back edges, corresponding to pairs of neighboring agents that are not directly linked by a parent-child relationship (e.g. b₂-i₃). Given a node Xᵢ, we define:

parent Pᵢ/children Cᵢ: Xᵢ's ancestor/descendants directly connected to Xᵢ via tree-edges (e.g. Pᵢ₃=b₃, Cᵢ₂={b₁,b₃}).

pseudo-parents PPᵢ: Xᵢ's ancestors directly connected to Xᵢ via back-edges (PPᵢ₃={b₂}).

pseudo-children PCi: Xᵢ's descendants directly connected to Xi via back-edges (e.g. PCᵢ₁={b₁}).

Sepᵢ is the separator of Xᵢ: ancestors of Xᵢ which are directly connected with Xᵢ or with descendants of Xᵢ (e.g. Sep_{b3}={i₂, b₂}).

TNᵢ are the tree neighbors of Xᵢ (nodes linked to Xᵢ via tree edges). TNᵢ=Pᵢ ∪ Ci.

Following the DPOP algorithm in [2], the pseudo-tree is obtained from the constraint graph in FIG. 4 by first running a decentralized leader election algorithm in order to decide upon the root of the pseudo-tree. Once the, root has been identified, it initiates a decentralized DFS traversal of the graph. Any standard algorithm can be used for both leader election and DFS traversal.

The particular DFS-traversal algorithm used in [2] has several drawbacks, especially in terms of privacy: agents may gather sensitive information about the structure of the constraint graph, and hence about their competitors in auctions in which they take part.

These drawbacks are common to the vast majority of distributed algorithms for generating DFS trees. The following sections describe a modified version of the DFS generation protocol from [2]. This new version provides additional privacy guarantees as well as possible performance improvements.

5.4.1 Secure Leader Election

The DFS generation protocol starts from a node which is designated as the root of the DFS tree. To choose such a node, we require an anonymous leader election protocol, with the following desirable properties:

1. Only the leader knows it is the leader;

2. The leader has a way to prove it is the leader if necessary (e.g. if another agent tries to pretend it is the leader).

3. In cases where the problem is initially disconnected, any leader election algorithm, when executed by all agents in the problem will elect exactly as many leaders as there are connected components.

We present in the following a possible El-Gamal encryption scheme for anonymous leader selection. This scheme uses a circular ordering of the agents in the system, which we present first.

5.4.1.1 Establishing a Circular Communication Structure

In order to carry out the leader election scheme, the agents need to first establish a circular communication structure. To do this, they construct an initial DFS tree in the following way.

1. Each agent has a unique ID, and knows an upper bound n on the number of agents in the problem. Each agent creates a local variable i and iteratively sets it to the maximum of its own ID and the value of i of any of its neighbors, where a neighbor is an agent that it shares a constraint with. After n iterations, each agent compares the value of i with its ID. The agent for which the two values are equal starts the DFS tree construction as described below.

2. To construct a circular ordering, the root starts the construction a DFS ordering by using any DFS traversal algorithm, such as the one described in Section 5.4.2.

5.4.1.2 El Gamal Encryption Scheme for Leader Election

After execution of this algorithm, the agents have a circular structure. We now move on to the actual leader election protocol:

1. For the entire system, we select a cyclic group with generator g and modulus q. All operations below are done modulo q. We order agents circularly as in the previous paragraph so that Aᵢ₊₁ follows Aᵢ modulo n. We call the circularly next agent in the order, A_{i+1(modn)}, the neighbor of Ai. Initialize n to the number of agents (and rounds of picking the leader).

2. Every agent i selects a random xᵢ (between 1 and q−1) as its secret key.

3. Key distribution: the agents generate cooperatively a joint key h=g^{x1·x2· . . . ·xn}. Each agent Aᵢ generates g^{xi} and then sends it to its neighbor. The neighbor Aⱼ raises it to its secret xⱼ-th power, and this is iterated until each agent has received its (transformed) key back. At the end, all agents hold h.

4. Every agent Aᵢ creates a vector wᵢ of n random numbers ε [1 . . . q−1]. It sets the element at its own position, wᵢ(i), to 1. It encrypts every element wᵢ(k) into two numbers uᵢ(k) and vᵢ(k) using El-gamal encryption:

vᵢ(k)=g^{y(k)}

uᵢ(k)=wᵢ(k)*h^{y(k)}

where the y(k) are distinct random numbers.

5. Every agent Aᵢ picks a random shift sᵢ ε [0 . . . n−1]. It shifts the vectors vᵢ and uᵢ circularly to the left by sᵢ positions and sends this vector to the neighbor.

Every agent Aⱼ who receives vectors uᵢ and vᵢ from its neighbor Aᵢ generates newly randomized vectors

vⱼ(k)=vᵢ(k)^{y(k)}uⱼ(k)=uᵢ(k)^{y(k)}

where the y(k) are again distinct random numbers. It then shifts both vectors circularly to the left by, sⱼ positions and sends them to its neighbor. This step repeats until every agent receives its (transformed) original vector back.

6. To select the first root agent, an agent i takes the first element of vector vᵢ and sends it to the next agent (mod n). The next agent, Aⱼ, raises it to its secret power, xⱼ, and sends it to the next agent (mod n). The process repeats until each agent gets its own (transformed) value back. It then raises it to its own secret power xᵢ to obtain tᵢ. It then computes

w=uᵢ/vᵢ

If w=1, then it is the unique agent at the root of the tree, if it is another value, then it is not. Note that if the result is not 1, it is one of the other elements raised to a random power; simple comparison would not suffice to determine how much the vector has been shifted.

7. To pick the next root, all agents drop the first element of the vector, set n←n−1, and repeat the protocol from step 5. Notice that we cannot use the same vector to determine the next choice: once an agent has been the first, it knows how many positions the vector has been permuted so it knows the positions of all the others. So we have to again rotate the vector by a random amount before picking the next root as the first element.

5.4.2 Anonymous DFS Tree Generation

This section describes two methods to generate DFS trees.

5.4.2.1 Generation of the Agent-Level DFS Tree

The algorithm we present in the following is a variation of the one used in [2]. The most important distinction is that in this version, the DFS tokens that are circulated do not contain any information about the nodes that were already visited, thus leaking much less private information.

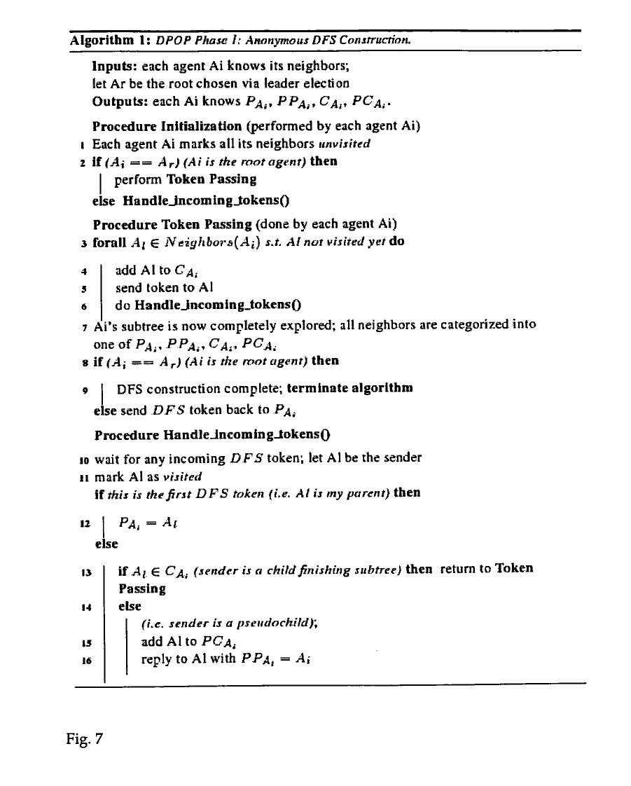

The method for DFS tree generation is described in Algorithm 1 (see FIG. 7). In cases where the problem is initially disconnected, multiple DFS trees are generated for disconnected problems, by simply initiating DFS token passing processes from each leader elected in Section 5.4.1.

Each agent maintains a label for each one of its neighbors, which is initially unvisited. The leader agent sends a token to one of its neighbors. A token is simply an empty message, which has the purpose of ensuring that the DFS traversal of the graph happens in a synchronous, sequential manner. During the whole algorithm, there is a single DFS token in the system at all times (one for each connected component, in case the problem is disconnected). This ensures that there is a single DFS traversal process happening at all times, and that upon finishing the algorithm, all agents have a consistent (partial) view of the DFS tree they have created.

Subsequently, agents wait for the token to be sent to them, and pass it on to their neighbors. Whenever an agent receives a token from a neighbor, it labels the sender as visited. When an agent Aᵢ receives the token for the first time, it also marks the sender as its parent. Then, it sends the token to one of its unvisited neighbors; let this be agent Aⱼ, which is marked now as Aᵢ's child. After sending Aⱼ the token, Aᵢ waits for the token to return. The token thus circulates through the graph, and eventually returns to agent Aᵢ. If it returns from agent Aⱼ, then Aᵢ repeats the process by sending it to another unvisited neighbor.

If the token returns from another agent Aₖ, then this means that a cycle is present in the graph, and that agent Aₖ is a pseudochild to Aᵢ. Since the tokens do not contain any information in this version of the algorithm, agent Aᵢ needs to inform agent Aₖ of the fact that Aᵢ was already visited, and Aₖ is actually Aᵢ's pseudochild. Otherwise, Aₖ would think that Aᵢ is a child to Aₖ, not a pseudoparent. Therefore, Aᵢ sends a message PP_{Ak}=Aᵢ to Ak.

When an agent receives the token, and has no more unvisited neighbors to send it to, it backtracks by sending the token back to its parent. This acknowledges that the agent has finished exploring the whole subgraph that was reachable from it. When the root is also in this situation, the algorithm terminates, and at this point, all nodes have a partial, consistent view of the DFS arrangement that they have created.

### EXAMPLE 1

### (DFS Construction Example)

Let us follow the execution of Algorithm 1 on the auction example in FIG. 4. Assume that agent i₁ was chosen as the root by the secure leader election protocol. Being the root, agent i₁ goes on to execute Token Passing, while all other agents, execute Handle incoming tokens, i.e. they wait for incoming tokens (line 9).

Agent i₁'s neighbors are the two bidders interested in item i₁: b₁ and b₂. Both b₁ and b₂ were marked as unvisited (line 1). Let us assume that agent i₁ decides to visit first its neighbor b₂. It does so by sending it a DFS token (an empty message).

Agent b₂ receives the token and marks i₁ as visited (lines 9 and 10). As this is the first token that b₂ received so far, b₂ also marks i1 as its parent (line 11). Agent b₂ then goes on to explore its own neighbors (lines 3-5). It has 2 neighbors that are not yet visited: i₂ and i₃. Assume it chooses i₂ to visit next, thus it sends the DFS token to agent i₂.

Agent i₂ receives the token and marks b₂ as its parent. i₂ has 2 neighbors that are not yet visited: b₁ and b₃. Assume it chooses b₁ to visit next, thus it sends the DFS token to agent b₁.

Agent b₁ receives the token and marks i₂ as its parent. b₁ has one neighbor that is not yet visited: i₁, therefore it can only send the DFS token to i₁.

Notice that i1 was actually already visited, but b₁ is not aware of this. This is due to the fact that the DFS construction process is anonymous, and the DFS tokens do not carry any information about what nodes were already visited. This preserves privacy to some extent, because no node can know what other nodes have already been visited before it received the token.

When i1 receives the token from b₁, it realizes that b₁ must be a pseudochild, since it originally sent the token to b₂, and now it receives it back from b₁ instead of b₂ (lines 13-15 in Algorithm 1). Therefore, i1 marks b₁ as a pseudochild (line 14), and announces b₁ that it is its pseudoparent, by sending it the message PP_{b1}=i₁.

Agent b₁ receives the message PP_{b1}=i₁, and marks i₁ as its pseudoparent. Since b₁ has no more unvisited neighbors, it now returns the DFS token to i₂. Thus, agent i₂ understands that its child b₁ has finished exploring its subtree. However, agent i₂ has another unvisited neighbor, b₃. Therefore, it contines the DFS construction process by sending the DFS token to b₃. b₃ sends the token to i₃, which sends it to b₂, which replies with PPᵢ₃=b₂.

From this moment onwards, all nodes have been visited, and the DFS token simply backtracks along i₃-b₃-i₂-b₂-i₁. When the token reached i₁, the process is complete.

The algorithm we presented works as expected under the assumption that all the local problems of the agents have a Hamiltonian path visiting each one of the internal variables exactly once without visiting any external variables. This is always the case for sellers, as long as each seller has exactly one item. The reason is that all the variables of the seller are connected by the constraint that there can be at most one of them taking value 1.

However, this may not always be the case for bidders; for example, if a bidder has a purely additive utility for two items, then this maps into a local problem with two disconnected variables, each having a unary relation expressing the bidder's utility for getting the item.

If such a Hamiltonian path through a local problem does not exist, this approach creates one by logically adding the missing (dummy) corresponding edges in the local problem graph. This approach has the advantage that all variables of an agent are grouped together. However, it may artificially increase the complexity of the solving algorithm, as the induced width of the constraint graph may increase.

5.4.2.2 Generation of the Variable-Level DFS Tree

Each agent internally treats its local variables individually, DFS-traverses connected components, and continues the DFS traversal by visiting other agents before returning to its other connected components.

This approach does not guarantee that all variables of an agent will appear in a single block in the DFS tree, which means that an agent may be present in several places in the tree. It has the advantage that the complexity of the solving algorithm is not artificially increased by creating dummy edges in the constraint graph.

5.5 UTIL Propagation Phase

The UTIL propagation starts bottom-up from the leaves and propagates upwards only through tree edges, from children to parents. A UTIL message sent by Xᵢ to its parent Xⱼ informs Xⱼ how much utility u*_{Xi}(v(j, k)) each one of its values v(j, k) gives to the whole subtree rooted at Xᵢ in the optimal solution.

To compute the UTIL message for its parent, Xⱼ has to join the messages it received from all its children, and the relations it has with its parent and pseudoparents. Afterwards, it projects itself out of the join and sends the result to its parent. The result of the projection is in fact the set of optimal utilities that can be obtained by the subtree rooted at this node, plus the relations it has with its parent/pseudoparents, for each combination of values of the parent/pseudoparents (see [2]).

TABLE 13
UTIL message UTIL_{b1→i2} in the DPOP
algorithm in [2]

| | x(1, 2) = 0 | x(1, 2) = 1 |
|---|---|---|
| x(1, 1) = 0 | 0 | 2 |
| x(1, 1) = 1 | 5 | 11 |

TABLE 14
UTIL message UTIL_{b1→i2} eencrypted with respect to x(1, 1) by
adding the random vector (r0, r1)^{T} = (12345, 23456)^{T} to
each column

| | x(1, 2) = 0 | x(1, 2) = 1 |
|---|---|---|
| x(1, 1) = 0 | 12345 | 12347 |
| x(1, 1) = 1 | 23461 | 23467 |

5.5.1 Generating and Encrypting UTIL Messages

In the standard DPOP algorithm [2], the UTIL message UTIL_{b1→i2} that bidder b₁ sends to the auctioneer for item i₂ would be of the form presented in Table 13. In this example, the utility that b₁ assigns to item i₁ alone is 5(x(1,1)=1 and x(1, 2)=0), its utility for item i₂ alone is 2 (x(1,1)=0 and x(1, 2)=1), and the utility it assigns to the combination of the two items is 11 (x(1,1)=1 and x(1, 2)=1). In other words, it does not assign much value to each item taken alone, but it is very interested in getting them together as a bundle.

If b₁ sent this UTIL message to the auctioneer for item i₂ as is, the auctioneer would have direct access to private information regarding b₁'s preferences for item i₁. The following paragraphs introduce a protocol that guarantees that this information remain hidden.

5.5.1.1 Obfuscating Private Valuations by Addition of Random Values

In order to hide b₁'s preferences for item i₁ from agents that do not need access to this information, bidder b₁ and the auctioneer for item i₁ agree on a secret vector of arbitrarily large random values rₓ(1,1)=(r₀, r₁)^{T} that b₁ should add to its valuations, so as to obfuscate them from agents that do not have access to rₓ(1, 1). The auctioneer only needs to choose rₓ(1, 1) and send it to bidder b₁ through a secure channel; b₁ then encrypts its UTIL message with this secret random vector. Intermediate computations on the UTIL message performed by other agents then operate on the encrypted valuations, without the need to decrypt them. When the auctioneer for item i₁ eventually receives the result of these computations, it simply subtracts rₓ(1, 1) in order to decrypt the message.

The encrypted UTIL message corresponding to the example in Table 13 is presented in Table 14. This encryption scheme provides one important improvement with respect to sending an unencrypted message: the auctioneer for item i₂ no longer has access to the exact valuations that b₁ assigns to item i₁.

However, the encrypted UTIL message in Table 14 still leaks out some information about b₁'s combined valuations for both items: by comparing the marginal utility for item i₂ if x(1,1)=0, which is equal to 12347−12345=2, to the same marginal utility if x(1, 1)=1, which is then 23467−23461=6, the auctioneer for item i₂ is able to infer that bidder b₁ assigns a much higher value to item i₂ if it also gets item i₁. The following paragraphs describe a method to hide this information that bidder b₁ might not want to reveal to the auctioneer for item i₂.

TABLE 15
UTIL message UTIL_{b1→i2} encrypted with respect to x(1, 1) from
the message in Table 14 by using the codename v as an alias for x(1, 1)

| | x(1, 2) = 0 | x(1, 2) = 1 |
|---|---|---|
| V = 0 | 12345 | 12347 |
| V = 1 | 23461 | 23467 |

5.5.1.2 Hiding Participation to Other Auctions Using Variable Codenames

As illustrated in the previous paragraph, the encryption method introduced so far (adding random values) still leaks out information about which other auctions the bidder sending the UTIL message is taking part in. The following paragraphs introduce a second encryption protocol that guarantees that this information remain hidden.

Following this second protocol, in addition to sending to b₁ a random vector rₓ(1,1), the auctioneer for item i₁ also sends a secret codename v that b₁ should use in lieu and place of x(1,1) in its UTIL message. The resulting encrypted message is presented in Table 15.

Upon receiving the encrypted message in Table 15, the auctioneer for item i₂ is still able to infer that b₁'s valuations with respect to i₂ depend on the result of some other auction, but it is unable to know which one, since this auction is identified by a secret codename v. This secret auction might not even involve bidder b₁ itself.

5.5.1.3 Additional Strong Privacy Guarantees

This section describes the guarantees provided by the method with respect to protected the agents' private information.

5.5.1.3.1 Privacy Gurantees Provided by the Tree Structure

The two encryption protocols presented in the previous sections were introduced in order to provide privacy guarantees on information intended for one agent, and that need to travel through intermediate agents from which this information should be kept secret. This is the case whenever there exists a back-edge in the pseudo-tree: the information about the relation represented by the back-edge should not be made available to intermediate agents between the two agents involved in the back-edge. In the example of FIG. 6, these protocols prevent the auctioneer for item i₂ to eavesdrop on b₁'s preferences with respect to item i₁, which only the corresponding auctioneer at the top of the pseudo-tree must know about.

Such encryption techniques are not even necessary when it comes to preventing private information leakage between branches in the pseudo-tree. Due to the nature of the DPOP algorithm, in which UTIL messages travel only through tree edges, two agents located in separate branches of the pseudo-tree never exchange messages and never have access to any private information about each other. For instance, in FIG. 6, bidder b₃ never sees the UTIL message UTIL_{b1→i2} sent by bidder b₁ and that contains information about b₁'s bid in the auction for item i₂, in which b₃ is also taking part. In fact, b₁ and b₃ do not even learn about each other's existence.

TABLE 16
Plaintext UTIL message UTIL_{i3→b3}
The value −M represents −∞, for M carefully
chosen big enough.

| | x′(3, 3) = 0 | x′(3, 3) = 1 |
|---|---|---|
| x′(2, 3) = 0 | 0 | 0 |
| x′(2, 3) = 1 | 0 | −M |

TABLE 17
Encrypted UTIL message UTIL_{i3→b3}
obtained after adding the random vector (r′₀, r′₁)^{T} = (34567,
45678)^{T} to each column, and replacing
x′(2, 3) by its codename μ, agreed upon with
bidder b₂

| | x′(3, 3) = 0 | x′(3, 3) = 1 |
|---|---|---|
| μ = 0 | 34567 | 34567 |
| μ = 1 | 45678 | <45678 |

5.5.1.3.2 Modeling Mutual Exclusion (Hard) Constraints

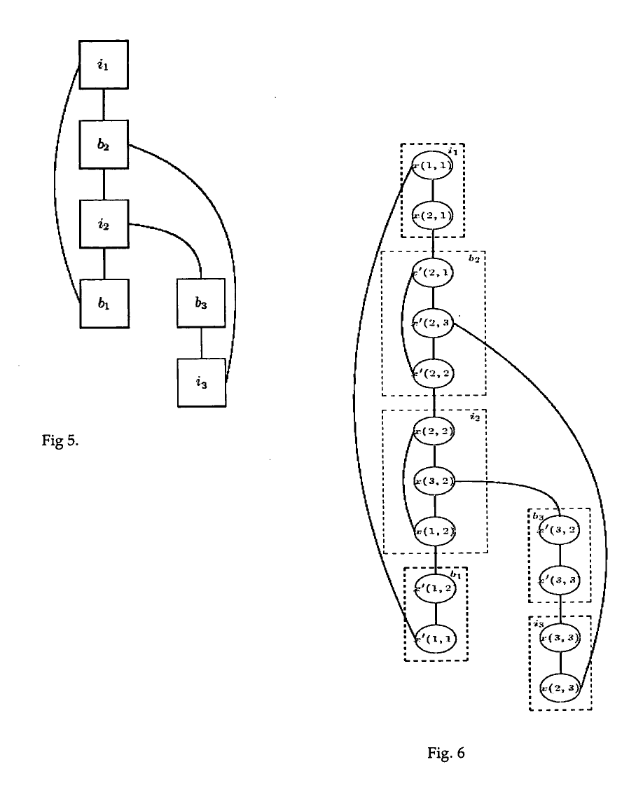

Each item i₁ can obviously be sold to a single bidder, hence at most one of the variables x(l,k) which model the interest of bidders bₖ may take value 1 (see Section 5.2.1). This type of constraint can lead to potential privacy losses, as a bidder could infer that there are other bidders interested in the same items. To see this, consider the example from FIG. 5, where auctioneer i₃ is under bidders b₃ and b₂. Table 16 shows the constraint that x(2,3) and x(3,3) cannot take both value 1: this combination is forbidden by the large negative valuation—M.

The message i₃ sends to b₃ has to carry this information, such that during the VALUE propagation phase, at most one “1” is chosen for x(2,3) and x(3,3). Similarly to the way bidder b₁ encrypts its UTIL message in order to obfuscate information about item i₁ to the auctioneer for item i₂, in the parallel branch of the pseudo-tree (FIG. 6), the auctioneer for item i₃ must also hide the information about bidder b₂'s participation to the auction from bidder b₃. This is illustrated in Tables 4 and 5.

A potential problem exists related to the choice of a value for M. If M is chosen very big, b₃ will be able to identify it, and infer that μ corresponds to another bidder for the same auction. More generally, with this representation of hard constraints, any bidder that is above its auctioneer can infer the number of other bidders for the auction that are higher in the tree, and their corresponding variable codenames.

The solution to this problem is to choose M just big enough to maintain soundness, but not too big, so that it looks like a valid valuation. Also, each auctioneer should choose its own value for M, depending on a known upper bound on all marginal valuations for the item. This upper bound would only be known by the auctioneer, and could require every bidder higher in the tree to send an upper bound on its marginal valuation (through secure channels).

5.5.1.4 Avoiding Codename Clashes

In the encryption scheme presented in the previous paragraphs, nothing prevents the auctioneer for item i₂ and bidder b₂ to independently choose the same codename for their respective variables x(1,1) and x′(2,3). This would be a problem because the auctioneer for item i₂, when receiving two messages containing the same codename, would then want to join these dimensions. Prohibiting agents from joining encrypted dimensions would not solve the problem, since bidder b₂, when receiving a message with two dimensions identified with the same codename, would not be able to tell which of the two corresponds to its variable.

In order to avoid such codename clashes, agents choose their codenames according to the following procedure, which can be seen as a new phase between the pseudo-tree generation phase and the UTIL propagation phase. This procedure is a top-down propagation procedure, during which CODE messages, containing codenames already taken, are exchanged.

The procedure is initiated at the root agent, which, in FIG. 6, is the auctioneer for item i₁, with the following empty CODE message:

CODE_{→i1}=0.

When receiving a CODE message, each agent chooses codenames for the variables it needs to encrypt (if any) such that they are not contained in the incoming CODE message. It then adds its codenames to the message and passes it on to its child agent, after sharing the codenames with its corresponding pseudo-children over secure channels. In the example in FIG. 6, the auctioneer for item i₁ chooses the codename v for its variable x(1,1) (with v ∉ CODE_{→i1}). It sends this codename to bidder b₁ over a secure channel, and sends to bidder b₂ the following new CODE message:

CODE_{i1→b2}=CODE_{→i1}∪{v}={v}.

Later in the CODE propagation phase, when receiving a CODE message containing v, bidder b₁ will remove it from the message so that agents down its branch do not learn about the existence of this codename. Note that if one of these agents later chooses v again for one of its variables, this will not create any codename clash, because the corresponding backedges would not overlap.

Similarly, upon reception of the CODE message CODE_{i1→b2}, bidder b₂ chooses a codename μ for variable x′(2,3) that is not contained in the message, communicates this secret codename to the auctioneer for item i₃ over a secure channel, and sends to its child agent the following CODE message:

CODE_{b2→i2}=CODE_{i1→b2}∪{μ}={v,μ}.

The auctioneer for item i₂ has no variable to encrypt and is not the leaf of any backedge, therefore it simply passes on the incoming CODE message unchanged to its child agents. In theory, in FIG. 6, the left branch containing bidder b₁ does not need to know about the existence of codename μ, since no overlapping with the μ-backedge would be possible, so that any agent in that branch can safely choose μ again as a codename without risking a codename clash. Similarly, in theory, the auctioneer for item i₂ only needs to send codename μ to the right branch. However, in practice, the auctioneer for item i₂ does not know which branches contain the leaves of which backedges; the messages that it sends to each branch are hence simply the same as the incoming message:

CODE_{i2→b1}=CODE_{b2→i2}={v,μ}

CODE_{i2→b3}=CODE_{b2→i2}={v,μ}.

If bidder b₁ had children, since it is the leaf of the v-backedge, it would first remove v from the incoming message CODE_{i2→b1} before passing it on to its child agents.

TABLE 18
Internal, plaintext utility matrix representing b₃'s private valuations

| | x′(3, 3) = 0 | x′(3, 3) = 1 |
|---|---|---|
| x′(3, 2) = 0 | 0 | 2 |
| x′(3, 2) = 1 | 4 | 7 |

TABLE 19
Encrypted UTIL message equal to the join of UTIL_{i3→b3} (Table 5)
with the plaintext matrix in Table 18

| | | x′(3, 3) = 0 | x′(3, 3) = 1 |
|---|---|---|---|
| x′(3, 2) = 0 | μ = 0 | 34567 | 34569 |
| | μ = 1 | 45678 | <45678 |
| x′(3, 2) = 0 | μ = 0 | 34571 | 34574 |
| | μ = 1 | 45682 | <45682 |

This CODE propagation phase only incurs a very limited, acceptable loss of privacy. Consider the CODE message CODE_{i1→b2}={v} that bidder b₂ receives from the auctioneer for item i₁. Upon receiving this message, bidder b₂ is able to infer the existence of an encrypted backedge, identified with the codename v. There is no additional privacy loss here, since b₂ would have learned about this backedge during the UTIL propagation phase anyway. Consider now the CODE message CODE_{i2→b1}={v,μ} that bidder b₁ receives from the auctioneer for item i₂. Bidder b₁ is able to infer from this message the existence of the μ-backedge, which it would normally not know about because it involves a parallel branch in the pseudo-tree. This is however acceptable, since it does not learn anything more about this backedge than its bare existence; for instance, it does not have access to the root or the leaf of the backedge.

5.5.2 Joining Encrypted UTIL Messages

The previous sections explained how agents can encrypt their UTIL messages in order to hide private information from parent agents in the pseudo-tree for which this information is not intended. The following paragraphs show how these agents can reason and operate on encrypted UTIL messages without decrypting them.

5.5.2.1 Joining One Encrypted UTIL Message With a Plaintext Message

Upon receiving the encrypted UTIL message UTIL_{i3→b3} (Table 17), bidder b₃ needs to merge it with, its internal utility matrix representing its valuations with respect to the two auctions it is taking part in. This plaintext matrix is introduced in Table 18.

In order to join the encrypted UTIL message UTIL_{i3→b3} (Table 17) with the plaintext matrix in Table 18, bidder b₃ simply needs to sum up the columns in x′(3,3), without the need to decrypt the first message. The result is presented in Table 19. The message, which would normally be a 3-dimensional hypercube, is represented as a 2-dimensional table, with 2 merged dimensions for the rows.

Projecting out x′(3,3) and replacing x′(3,2) with x(3,2) yields the final encrypted UTIL message UTIL_{b3→i2} that bidder b₃ sends to the auctioneer for item i₂ (Table 20). No decryption is necessary to produce this message, such that the information that the auctioneer for item i₃ wants to hide from b₃ remains hidden.

TABLE 20
Encrypted UTIL message UTIL_{b3→i2} that bidder b₃ sends
to the auctioneer for item i₂

| | x(3, 2) = 0 | x(3, 2) = 1 |
|---|---|---|
| μ = 0 | 34569 | 34574 |
| μ = 1 | 45678 | 45682 |

TABLE 21
Intermediate UTIL message resulting from introducing variables
x(3, 2) and x(2, 2) and the constraint x(1, 2) + x(2, 2) + x(3, 2) ≦ 1
into the message UTIL_{b1→,i2} (Table 15)

| | | x(3, 2) = 0 | | x(3, 2) = 1 | |
|---|---|---|---|---|---|
| | | x(1, 2) = 0 | x(1, 2) = 1 | x(1, 2) = 0 | x(1, 2) = 1 |
| x(2, 2) = 0 | v = 0 | 12345 | 12347 | 12345 | −M |
| | v = 1 | 23461 | 23467 | 23461 | −M |
| x(2, 2) = 1 | v = 0 | 12345 | −M | −M | −M |
| | v = 1 | 23461 | −M | −M | −M |

5.5.2.2 Joining Two Encrypted UTIL Messages:

Consider the auctioneer for item i₂ that receives the two encrypted UTIL messages UTIL_{b1→i2} (Table 15) and UTIL_{b3→i2} (Table 20). In order to join these two messages, the auctioneer creates the intermediate, internal message UTIL_{x(1,2)→x(3,2)} out of the former. This is done by first introducing the two variables x(3,2) and x(2,2) and enforcing the constraint x(1,2)+x(2,2)+x(3,2)≦1, which leads to the message in Table 21. No decryption of UTIL_{b1→i2} is necessary.

The internal message UTIL_{x(1,2)→x(3,2)} is then obtained from Table 21 by projecting out variable x(1,2). This can also be done without decrypting the message, and in particular without subtracting the random values introduced by bidder b1, because the same random vector rₓ(1, 1)=(r₀, r₁)^{T} was added to the column x(1,2)=0 and the column x(1, 2)=1; hence comparing encrypted values on the same row is equivalent to comparing the original plaintext values, because the corresponding component in rₓ(1, 1) cancels itself out. For instance, for x(2,2)=0, v=0 and x(3,2)=0, we have: 12345−12347=(0+r₀)−(2+r₀)=0−2 which corresponds to the first row in Table 13. The UTIL message UTIL_{x(1,2)→x(3,2)} obtained after projecting out x(1,2) is presented in Table 22.

Joining this internal message UTIL_{x(1,2)→x(3, 2)} (Table 22) with the UTIL message UTIL_{b3→i2} from bidder b₃ (Table 20) then leads to the intermediate message presented in Table 23. Since both input messages are dependent on x(3,2), joining them involves adding up the columns in both messages. So far, no decryption of the messages was necessary, so that the private information from bidders b₁ and b₃ with respect to the other auctions they are respectively taking part in remain obfuscated.

TABLE 22
Internal UTIL message
UTIL_{x(1, 2) → x(3,2)} obtained after
projecting out x(1, 2) in Table 21

| | | x(3, 2) = 0 | x(3, 2) = 1 |
|---|---|---|---|
| x(2, 2) = 0 | ν = 0 | 12347 | 12345 |
| | ν = 1 | 23467 | 23461 |
| x(2, 2) = 1 | ν = 0 | 12345 | −M |
| | ν = 1 | 23461 | −M |

TABLE 23
Intermediate UTIL message obtained by joining
UTIL_{x(1,2) → x(3,2)} (Table 22) with
UTILb_{3→ i2} (Table 20)

| | | | x(3, 2) = 0 | x(3, 2) = 1 |
|---|---|---|---|---|
| μ = | x(2, 2) = 0 | ν = 0 | 12347 + 34569 = 46916 | 12345 + 34574 = |
| 0 | | | | 46919 |
| | | ν = 1 | 23467 + 34569 = 58036 | 23461 + 34574 = |
| | | | | 58035 |
| | x(2, 2) = 1 | ν = 0 | 12345 + 34569 = 46914 | −M + 34574 < 46914 |
| | | ν = 1 | 23461 + 34569 = 58030 | −M + 34574 < 58030 |
| μ = | x(2, 2) = 0 | ν = 0 | 12347 + 45678 = 58025 | 12345 + 45682 = |
| 1 | | | | 58027 |
| | | ν = 1 | 23467 + 45678 = 69145 | 23461 + 45682 = |
| | | | | 69143 |
| | x(2, 2) = 1 | ν = 0 | 12345 + 45678 = 58023 | −M + 45682 < 58023 |
| | | ν = 1 | 23461 + 45678 = 69139 | −M + 45682 < 69139 |

Finally, projecting out x(3,2) and replacing x(2,2) with x′(2,2) (by virtue of x(2,2)=x′(2,2)) yields the UTIL message UTIL_{i2→b2} that the auctioneer for item i₂ sends to bidder b₂, presented in Table 24. The projection operation works without decrypting the message, following the same argument as previously.

5.5.3 Decrypting UTIL Messages

The UTIL message UTIL_{i2→b2} (Table 24) that bidder b₂ receives from the auctioneer for auction i₂ contains variable μ, which is the codename for variable x′(2,3), owned by b₂. To be able to project this variable out in the process of computing the UTIL message to be sent to its parent, b₂ needs to decrypt the message with respect to μ. To do this, it applies the inverse transformations of the two encryption schemes that b₃ applied to encrypt its message.

The first step of the decryption process hence consists in replacing the codename μ by its true variable name x′(2,3). In the second step, b₂ subtracts the random vector (r₀′, r₁′)^{T}=(34567,45678) that b₃ has added to its UTIL message to encrypt it, and that has been carried through all the consecutive operations performed by intermediate agents. The resulting version of UTIL message UTIL_{i2→b2}, decrypted with respect to x′(2,3), is given in Table 25.

TABLE 24
Encrypted UTIL message
UTIL_{i2→b2} that the auctioneer for item i₂
sends to bidder b₂

| | | | |
|---|---|---|---|
| μ = 0 | x′(2, 2) = 0 | ν = 0 | 46919 |
| | | ν = 1 | 58036 |
| | x′(2, 2) = 1 | ν = 0 | 46914 |
| | | ν = 1 | 58030 |
| μ = 1 | x′(2, 2) = 0 | ν = 0 | 58027 |
| | | ν = 1 | 69145 |
| | x′(2, 2) = 1 | ν = 0 | 58023 |
| | | ν = 1 | 69139 |

TABLE 25
UTIL message UTIL_{i2→b2,}
decrypted with respect to x′(2, 3) after
resolving the codename μ and subtracting
the random vector (r₀′, r₁′)^{T} = (34567,
45678)^{T}

| | | | |
|---|---|---|---|
| x′(2, 3) = 0 | x′(2, 2) = 0 | ν = 0 | 12352 |
| | | ν = 1 | 23469 |
| | x′(2, 2) = 1 | ν = 0 | 12347 |
| | | ν = 1 | 23463 |
| x′(2, 3) = 1 | x′(2, 2) = 0 | ν = 0 | 12349 |
| | | ν = 1 | 23467 |
| | x′(2, 2) = 1 | ν = 0 | 12345 |
| | | ν = 1 | 23461 |

The next step in the process of computing the UTIL message UTIL_{b2→i1} consists in joining UTIL_{i2→b2} (Table 25) with b₂'s combined utilities with respect to all three items (Table 26).

Note that there is no use for b₂ to encrypt these utilities, since there is no third agent between itself and auctioneer i₁ that could eavesdrop over a potential back-edge. The resulting join is given in Table 15. Tables 28 and 29 show the results of projecting out x′(2,2) and x′(2,3), successively. Replacing x′(2,1) with x(2,1), Table 29 then corresponds to the UTIL message UTIL_{b2→i1}.

Finally, after receiving the UTIL message UTIL_{b2→i1}, the auctioneer for item i₁ decrypts the message with respect to v, which is the codename for x(1,1) that bidder b₁ initially used to encrypt its UTIL message. The result of the two-step decryption process, involving replacing v with x(1, 1), and subtracting the random vector (r₀, r₁)^{T}=(12345,23456)^{T} from each column, is presented in Table 30.

The very last step in the UTIL propagation phase consists, for the auctioneer for i₁, in joining its incoming UTIL message UTIL_{b2→i1} (Table 30) with the hard constraint x(1,1)+x(2,1)<1, which produces the final internal message in Table 31. This step is simply equivalent to pruning out the case (x(1,1), x(2,1))=(1, 1), which would correspond to selling item i₁ to both bidders b₁ and b₂.

The following section shows how the auctioneer uses this last message to initiate the VALUE propagation phase, during which the winners of all three auctions are determined sequentially.

TABLE 26
Bidder b₂'s combined utilities with respect to all three items:
b₂ prefers i₁ over i₂ and i₂ over i₃.

| | | x′(2, 1) = 0 | x′(2, 1) = 1 |
|---|---|---|---|
| x′(2, 3) = 0 | x′(2, 2) = 0 | 0 | 4 |
| | x′(2, 2) = 1 | 2 | 7 |
| x′(2, 3) = 1 | x′(2, 2) = 0 | 1 | 6 |
| | x′(2, 2) = 1 | 4 | 7 |

TABLE 27
Intermediate message resulting from the join of
UTIL_{i2→b2} (Table 13) with b₂'s
combined utilities (Table 26)

| | | | x′(2, 1) = 0 | x′(2, 1) = 1 |
|---|---|---|---|---|
| x′(2, 3) = 0 | x′(2, 2) = 0 | ν = 0 | 12352 | 12356 |
| | | ν = 1 | 23469 | 23473 |
| | x′(2, 2) = 1 | ν = 0 | 12349 | 12354 |
| | | ν = 1 | 23465 | 23470 |
| x′(2, 3) = 1 | x′(2, 2) = 0 | ν = 0 | 12350 | 12355 |
| | | ν = 1 | 23468 | 23473 |
| | x′(2, 2) = 1 | ν = 0 | 12349 | 12352 |
| | | ν = 1 | 23465 | 23468 |

TABLE 28
Intermediate message resulting from the projection of x′(2, 2)
out of the message in Table 27

| | | x′(2, 1) = 0 | x′(2, 1) = 1 |
|---|---|---|---|
| x′(2, 3) = 0 | ν = 0 | 12352 | 12356 |
| | ν = 1 | 23469 | 23473 |
| x′(2, 3) = 1 | ν = 0 | 12350 | 12355 |
| | ν = 1 | 23468 | 23473 |

TABLE 29
Encrypted UTIL message UTIL_{b2→i1} after projecting
x′(2, 3) out of the message in Table 28 and replacing x′(2, 1) with x(2, 1)

| | x(2, 1) = 0 | x(2, 1) = 1 |
|---|---|---|
| ν = 0 | 12352 | 12356 |
| ν = 1 | 23469 | 23473 |

TABLE 30
Decrypted UTIL message UTIL_{b2→i1}

| | x(2, 1) = 0 | x(2, 1) = 1 |
|---|---|---|
| x(1, 1) = 1 | 7 | 11 |
| x(1, 1) = 1 | 13 | 17 |

TABLE 31
Final internal message obtained by joining UTIL_{b2→i1}
(Table 18) with the hard constraint x(1, 1) + x(2, 1) ≦ 1

| | x(2, 1) = 0 | x(2, 1) = 1 |
|---|---|---|
| x(1, 1) = 0 | 7 | 11 |
| x(1, 1) = 1 | 13 | −M |

5.6 VALUE Propagation Phase and Winner Determination

The previous sections described the UTIL propagation phase, during which utilities from various bidders are securely aggregated, leading to the final total utility matrix in Table 31, computed by the auctioneer for item i₁. This section demonstrates step by step the value propagation algorithm that is initiated by the auctioneer at the top of the pseudo-tree (FIG. 6), based on this matrix, and that leads to the determination of the winner in each auction.

The optimal assignment, according to the utility matrix, is (x(1,1), x(2,1))=(1, 0). In the DPOP algorithm in [2], the VALUE message that the auctioneer would then send to its child agent, bidder b₂, would be VALUE_{i1→b2}={x(1, 1)←1, x(2,1)←0}. Upon receiving this message, b₂ would discover the identity of its winning competitor (bidder b₁) in the auction for item i₁.

5.6.1 Encrypting VALUE Messages

A solution to this loss of privacy is to make b₁ anonymous, by referring to variable x(1, 1) using the same codename v that was used in the UTIL propagation phase previously described. The VALUE message then becomes:

VALUE_{i1→b2}={v←1, x(2,1)←0}.

When it receives this VALUE message, bidder b₂ must infer the optimal value assignments to its own variables x′(2,1), x′(2,2) and x′(2,3), satisfying the assignments specified in the VALUE message. For instance, since x′(2,1)=x(2,1), the only consistent assignment to variable x′(2,1) is x′(2,1)=0 (i.e. bidder b₂ does not get item i₁). The optimal assignments for the two remaining variables can be inferred from the utility matrix in Table 27. Given that x′(2,1)=0 and v=1, the couple of assignments that maximizes the encrypted, aggregated utility is (x′(2,2), x′(2,3))=(0,0) (bidder b₂ does not get any of the two other items it had placed a bid on). Note that decrypting the utility matrix with respect to variable v is not necessary, following the same argument used for projecting a variable out of an encrypted UTIL message, in the UTIL propagation phase.

It is important to notice here that, as briefly mentioned before, the DCOP model chosen provides strong privacy guarantees with respect to the knowledge of the winner of an auction. For instance, in the case of the auction for item i₂, bidder b₂, who lost the auction, only knows the fact that it lost it; it does not know the identity of the winner. More generally, for any auction, this scheme guarantees that only the auctioneer and the winner know who acquired the item.

Bidder b₂ subsequently generates the VALUE message:

VALUE_{b2→i2}={v←1,x′(2, 2)←0,x′(2,3)

that it sends to the auctioneer for item i₂. In order to protect the information about b₂ not being awarded item i₃ (x′(2,3)←0), which the auctioneer for item i₂ need not know, b₂ encrypts its VALUE message with respect to variable x′(2,3) using the same variable codename as the one used during the UTIL propagation phase; the resulting VALUE message is the following:

VALUE_{b2→i2}={v←1,x′(2, 2)←0, μ←0}.

Upon reception of this VALUE message, the auctioneer for item i₂ can infer from the constraint x(2,2)=x′(2,2) that x(2,2)=0(i.e. bidder b₂ does not get the item). It then uses the utility matrix in Table 23 to find the optimal, consistent assignment to variable x(3,2). The assignment that maximizes the encrypted, aggregated utility is x(3,2)=0, which corresponds to not selling item i₂ to bidder b₃.

From the utility matrix in Table 21, it can then infer that the optimal assignment to its remaining variable is x(1,2)=1 (bidder b₁ gets the item). The two VALUE messages that the auctioneer then sends to bidders b₁ and b₃ further down the tree are hence the following:

VALUE_{i2→b1}={v←1,x(1, 2)←1}

VALUE_{i2→b3}={μ←0, x(3,2)←0}.

5.6.2 Decrypting VALUE Messages

When it receives VALUE message VALUEi_{2→b1}, bidder b₁ can immediately infer that it was awarded item i₂. To discover whether it also won item i₁, it first needs to decrypt v←1, by replacing the codename by the corresponding variable name, following the association rule already used in the UTIL propagation phase. This yields x(1,1)←1, which means that b₁ also got item i₁. This is consistent with the fact that it had declared a high utility for the combination of the two items.

Similarly, bidder b₃ can directly infer from VALUE message VALUE_{i2→b3} that it did not win the auction for item i₂. As highlighted before, this is the only information it can discover about this auction: it cannot infer who won the auction. As far as item i₃ is concerned, the optimal assignment for variable x′(3,3) compatible with μ=0 is given by Table 19, and corresponds to x′(3,3)=1. Bidder b₃ can hence infer that it won item i₃.

Bidder b₃ then sends the following VALUE message to the auctioneer for item i₃:

VALUE_{b3→i3}={μ←0,x′(3,3)←1}.

When it receives this VALUE message, the auctioneer immediately discovers that bidder b₃ has won the auction. Decrypting μ←0 is not even necessary since it would only tell it that bidder b₂ was not assigned the item.

5.7 Fixing Item Prices

Sections 5.5 and 5.6 only described a protocol to determine the winner of each auction, based on how much utility each bidder assigned to the items it is interested in acquiring. The prices at which bidders then acquire the items they won still remain to be fixed. In this section, we describe a protocol to compute the payments that winning bidders should send to auctioneers to pay for the items they were awarded.

5.7.1 Interpreting UTIL Messages in Terms of Bids

The UTIL messages exchanged between agents during the UTIL propagation phase in Section 5.5 could be interpreted as bids that participants place on items or on bundles of items. To illustrate this, first consider b₁'s utility matrix with respect to items i₁ and i₂ (Table 13). The utilities assigned by the bidder to each item simply correspond to how much it values them, i.e. how much it is willing to pay for them. Its bid for item i₁ is therefore 5, for item i₂, it is of 2, and b₁ is willing to pay 11 for the combination of both items. It is however still unclear, in case it wins both items, how this combined payment of 11 will be split among the two corresponding auctioneers. This will be described in Section 5.7.3.

When the auctioneer for item i₂ receives the encrypted version of b₁'s utility matrix (Table 15), it could be tempted to infer from the message how much bidder b₁ is willing to pay for its item, without decrypting the protected information. This would be done by computing the difference between the two columns, corresponding to whether b₁ wins the auction (x(1,2)=1) or loses it (x(1, 2)=0). In this example, the auctioneer learns that bidder b₁ would pay 12347−12345=2 for the item if v=0, and 23467−23461=6 if v=1. Note that this corresponds to b₁'s private marginal utilities with respect to item i₂, in Table 13. The auctioneer however does not know this fact: it only knows that the UTIL message it receives is an aggregation of the utilities of all agents below itself in the pseudo-tree. Not knowing the structure of the subtree rooted at b₁, it cannot reliably infer that the marginal utilities in the message correspond only to b₁'s, or are the result of the aggregation of the utilities from several agents and/or for several items.

An example that illustrates this difference is given by the (decrypted) UTIL message UTIL_{b2→i1} that bidder b₂ sends to the auctioneer for item i₁ (Table 30). By computing the difference between the columns (and ignoring the illegal case x(1,1)=x(2,1)=1), the auctioneer can infer that the overall group of bidders below itself in the tree is willing to pay 11−7=4 if x(2,1)=1. This case corresponds to awarding the item to its direct child b₂ in the tree for a price of 4, which is somewhat compatible with b₂'s private utilities in Table 26, according to which b₂'s marginal utility with respect to item i1 is between 3 and 5(depending on the result of other auctions). However, computing the difference between the rows in Table 30 yields that the bidders are willing to pay a value of 13−7=6 if x(1,1)=1. In this case, this aggregated bid obviously does not correspond to b₂'s private preferences, otherwise it would mean that b₂ is willing to pay 6 in order not to get the item. This illustrates the fact that UTIL messages sent by bidders do not encode their private utilities, but rather the aggregation of utilities of all bidders below in the pseudo-tree. The following section will also show that this marginal utility of 6 cannot be interpreted as the winning bidder's bid either, so that payments cannot be simply derived from UTIL messages.

5.7.2 General Protocol to Compute the Payments

As mentioned in the introduction to the previous section, it is not enough to know the bids that participants are placing on items or bundles of items: in the case of a bidder winning a bundle of items for a given price (equal to the amount of its combined bid), the protocol must also decide how the payment should be divided among auctioneers whose items constitute de bundle. This section describes a protocol that agents follow in order to compute the payments they should send to or claim from other agents.

As mentioned briefly in the previous section, payments cannot be simply taken equal to the marginal utilities given by UTIL messages. Assume that the auctioneer for item i₁ simply set the price for its item to the aggregated, marginal utility of 6 that its decision to award the item to bidder b₁ generates for its subtree. Bidder b₁ would then pay 6 for the item. Consider now the UTIL matrix that the auctioneer for item i₂ receives from the winner of the auction, bidder b₁(Table 15). Following the same simple rule, the auctioneer would set the price for its item either to 12347−12345=2 or to 23467−23461=6. In the first case, bidder b₁ would pay 6+2=8 for the combination of the two items, which would mean the auctioneers would globally be paid less than the utility of 11 that b₁ had declared for the two items in Table 13. In the second case b₁ would be asked to pay 6+6=12, which is more than what it was willing to pay.

The reason why this simple method does not work is the following. In the optimal assignment, bidder b₁ gets assigned both items i₁ and i₂, and item i₃ is sold to bidder b₃. This generates a total, aggregated utility of 13, as given in Table 30. To compute the marginal utility generated by the decision to assign its item to bidder b₁, the auctioneer for item i₁ compares this utility with the total, aggregated utility of 7 corresponding to not selling its item. However, not selling its item would trigger a reallocation of item i₂, which would then go to bidder b₃. This would generate an additional utility corresponding to the surplus in b₃'s combined bid for the bundle involving items i₂ and i₃. This additional utility coming from the reallocation of item i₂ is the reason why the aggregated, marginal utility that the auctioneer for item i₁ sees in the incoming UTIL message is lower than the price its should actually claim for its item.

To go around this issue, in our payment protocol, each agent a is going to send or claim payments equal to the marginal utility that its decisions generate for the whole group of other agents, all other decisions remaining the same (i.e. prohibiting real-location of items). Since the agents whose personal valuations depend explicitly on agent a's decisions can only be its children and pseudo-children, it is sufficient to compute the marginal utility that a's decisions bring to its subtrees. However, as we presented before, this marginal utility cannot be directly derived from the UTIL messages that agent a receives, since other agents' decisions are not guaranteed to remain the same across entries that agent a would compare in the UTIL messages.

In order to compute this marginal utility, agent a explicitly sends a request for its subtrees to “freeze” all decisions, and return the total aggregated utility that they would get if only its own decisions changed. More formally, each agent a executes the following protocol.

Agent a maintains a list A of assignments to variables, which is initialized with the assignments contained in the VALUE message received during the VALUE propagation phase, augmented with the optimal assignments to the variables it owns. It also maintains a variable u(A) that is initialized to the (possibly encrypted) total, aggregated utility that the assignments in A generate for its subtrees and itself.

For each of its variables x(b,i) (or x′(b,i)) whose currently assigned value is 1, agent a then changes its assignment to 0 in its list A, and sends the updated list in the form of ASSIGN messages to its children.

When receiving an ASSIGN message, each agent updates its own list A, whose relevant assignments it sends to its children. If the agent is a leaf, then it responds by starting a new UTIL propagation phase, during which all variables are set to the values specified in the agents' lists A, and agents update their variables u(A) according to the UTIL messages they receive.

When receiving the resulting single-entry UTIL messages from its children, agent a joins them all together with its personal utilities in order to compute the total, aggregated utility that would incur from setting variable x(b,i) to 0 rather than 1. Subtracting this utility from u(A) yields the payment that bidder b should send to the auctioneer for item i. Note that since a owns variable x(b,i) (resp. x′(b,i)), a is the auctioneer for item i (resp. bidder b). Agent a then finally updates its variable u(A).

The previous protocol is executed by all agents successively, starting with the root of the pseudo-tree and following its DFS order. Section 5.7.3 illustrates this general payment protocol on the example used in the previous sections.

5.7.3 Demonstration of the Payment Protocol

Consider the auction example whose pseudo-tree is presented in FIG. 6. The payment protocol starts at the root of the pseudo-tree, with the auctioneer for item i₁.

5.7.3.1 Payments Involving the Auctioneer for Item i₁

At first, this auctioneer's list of assignments A is initialized to the the optimal variable assignments given by the previous VALUE phase: Aᵢ₁={x(1, 1)←1,x(2,1)←0}. According to its aggregated utility matrix presented in Table 31, which is the result of the join of its incoming UTIL messages with its personal valuations, the total, aggregated utility corresponding to these assignments is u(Aᵢ₁)=13.

The agent considers the first (and only) variable it owns whose value is set to 1 (variable x(1,1)), and sets it to 0. It then updates its assignment list accordingly to Aᵢ₁={x(1, 1)←0, x(2,1)←0}, and sends it to its child in the form of the following message:

ASSIGN_{b2→i2}={v←0, x(2,1)←0}

in which it replaced variables by their codenames when necessary to protect private information.

Upon reception of this message, bidder b₂ updates its own assignment list A_{b2}, which then becomes A_{b2}={v←0, x(2,1)=x′(2,1)←0, x′(2,3)←0, x′(2, 2)←0}. It sends the relevant assignments to its child, where a specific assignment is relevant only if its variable was mentioned in the VALUE message that was previously sent to this child. In this case, the ASSIGN message is therefore the following:

ASSIGN_{b2→i2}={v←0, μ←0, x′(2, 2)←0}

where x′(2,3) was replaced by its codename μ.

When it receives this incoming ASSIGN message, the auctioneer for item i₂ updates its assignment list to Aᵢ₂={v←0,μ←0,x(2,2)=x′(2,2)←0,x(3,2)←0,x(1,2)←1}, and then sends the relevant assignments to its children, in the form of the following messages:

ASSIGN_{i2→b1}={v←0, x(1, 2)←1},

ASSIGN_{i2→b3}={μ←0, x(3,2)←0}.

It is very interesting to notice that, in this case, ASSIGN_{i2→b3}=VALUE_{i2→b3}; it is therefore not necessary for the agent to send this last message, since the aggregated utility value that the message is prompting bidder b₃ for is already contained in the UTIL message sent by b₃ during the previous UTIL propagation phase. As presented in Table 20, the encrypted, aggregated utility value corresponding to the assignments μ←0 and x(3,2)←0 is 34569.

After receiving the message ASSIGN_{i2→b1} and decrypting it, bidder b₁ updates its assignment list to A_{b1}={x(1, 1)←0, x′(1, 2)=x(1, 2)←1}. Then, since it has no children, it computes its personal, private utility corresponding to these assignments, which, according to Table 13, is equal to u(A_{b1})=2. This value in sent to its parent through a single-entry UTIL message:

UTIL_{b1→i2}={12347}

using the same random vector as in previous phases to encrypt its true valuation.

Note that this demonstration of the payment computation protocol uses the same random values used during the initial UTIL propagation phase (Section 5.5), in order to keep the description clearer. However, in order to ensure additional privacy, the agents should agree on a different random number used to encrypt UTIL messages. This ensures that third-party agents relaying these UTIL messages are not able to compare them with messages they relayed during previous UTIL phases, and learn some information about the dependance of their subtrees' aggregated valuations on the values of backedges.

The auctioneer for item i₂ then uses the utility in the message it receives to compute the aggregated utility for itself and all its children, and update its variable u(A) to u(Aᵢ₂)=12347+34569=46916. This utility is forwarded to its parent, bidder b₂, through the following UTIL message:

UTIL_{i2→b2}={46916}.

Bidder b₂ then does the same: it computes the new value of its variable u(A) by adding the aggregated utility in the incoming UTIL message (after partially decrypting it by removing the secret random number 34567) with the personal, private utility (Table 26) corresponding to its current assignment list A_{b2}, which is 0. It therefore enforces u(A_{b2})=12349, and forwards this information to its parent:

UTIL_{b2→i1}={12349}.

When finally reaching the agent that sent the first ASSIGN message, which is the auctioneer for item i₁, this message is decrypted (by subtracting the secret random number 12345) and used by the agent to compute the payment, equal to u(Aᵢ₁)−4=13−4=9. The auctioneer therefore asks for a payment of 9 from its winning bidder, bidder b₁, and updates its variable u(A) to u(Aᵢ₁)=4.

5.7.3.2 Payments Involving Bidder b₂

It is then up to bidder b₂, the next agent in DFS order after the auctioneer for item i₁, to compute the payments it might have to send. In the assignment list A_{b2}, all variables owned by b₂ are set to 0, therefore it has nothing to do, and no payment to send. This is consistent with the fact that bidder b₂ was not attributed any item.

5.7.3.3 Payments Involving the Auctioneer for Item i₂

Recall from the first iteration of the protocol that the assignment list of the auctioneer for item i₂ is Aᵢ₂={v←0, μ←0, x(2,2)←0, x(3,2)←0, x(1, 2)←1}. Similarly to the procedure that the auctioneer for item i₁ followed, the agent picks a variable it owns whose current assignment is 1 and sets it to 0 instead. The only such variable in this case is x(1,2). The agent updates Aᵢ₂, and sends its relevant assignments to its children, in the form of the following ASSIGN messages:

ASSIGN_{i2→b1}={v←0, x(1, 2)←0}, ASSIGN_{i2→b3}={μ←0, x(3,2)←0}.

Notice that ASSIGN_{i2→b3} is the same as in the first iteration, therefore it is not necessary to send it again: the agent already knows the corresponding aggregated utility value from the subtree rooted at bidder b₃, and this encrypted utility is equal to 34569.

As far as the utility from bidder b₁ is concerned, when receiving the message AS SIGN_{i2→b1}, bidder b₁ updates its assignment list to A_{b1}={x(1,1)←0, x′(1,2)=x(1, 2)←0} computes the corresponding new utility u(A_{b1})=0 from Table 13, and sends it up through the following encrypted UTIL message:

UTIL_{b1→i2}={12345}.

The auctioneer for item i₂ then sums up all aggregated utilities from its subtrees and from itself, which yields 12345+34569=46914. Comparing with the current value of u(Aᵢ₂), the auctioneer infers that it should ask bidder b₁ for a payment of u(Aᵢ₂)−46914=46916−46914=2. Note that the total payments that bidder b₁ must then send correctly adds up to its combined bid for the combination of items i₁ and i₂ (9+2=11).

5.7.3.4 Payments Involving Bidder b₁

When it comes to bidder b₁, its assignment list then contains only variables set to 0, and therefore it does not have anything to compute. This is consistent with the fact that its two payments for the two items it was awarded have already been computed by the corresponding auctioneers.

5.7.3.5 Payments Involving Bidder b₃

Following the DFS order, the next agent after bidder b₁ is bidder b₃, whose assignment list is initially A_{b3}={μ←0, x′(3,2)=x(3,2)←0, x′(3,3)←1}. The agent first sets variable x′(3,3) to 0, updates its list A_{b3}, and sends the following message to its child:

ASSIGN_{b3→i3}={μ←0, x′(3,3)←0}.

Upon reception of this message, the auctioneer for item i₃ decrypts it and updates its own assignment list to Aᵢ₃={x(2,3)=x′(2,3)←0,x(3,3)=x′(3,3)←0}. Its corresponding personal utility is 0, which it sends up to bidder b3 in the form of the following encrypted UTIL message:

UTIL_{i3→b3}={34567}.

Comparing this utility with the current value of u(A_{b3}), bidder b₃ infers that it should pay a price of u(A_{b3})−34567=34569−34567=2 for item i₃. Note that this corresponds to b₃'s private valuation for item i₃ alone.

5.7.3.6 Payments Involving the Auctioneer for Item i₃

As for bidder b₁, the payment that the auctioneer for item i₃ should receive has already been computed by other agents higher up in the tree, and the auctioneer has nothing to compute.

### 6 EXTENSIONS OF THE BASIC METHOD

This section presents a number of possible extensions that a skilled practitioner can easily make to our proposed protocol.

6.1 Other Leader Election Protocols

Apart from the leader election protocol introduced in Section 5.4.1, one can use essentially any other secure leader election protocol which satisfies the properties listed in Section 5.4.1: only the leader knows it is the leader, and no agent can manipulate the protocol to become the leader.

We present in the following another version of a leader election protocol. This version chooses the agent with the smallest ID. Assume that every agent Ai has an unique ID kᵢ ε 1 . . . m. m has to be much larger than n, the actual number of agents in the system, and the ID's have to be randomly distributed in the interval 1 . . . m. To see why this is important, consider the case where all ID's are numbers from 1 to n (n is the number of agents). Since the protocol always chooses the node with the smallest ID, it is obvious to all agents that always agent 1 will be chosen as the root.

Every node encodes their number in a vector of kᵢ 1's followed by (m−kᵢ) a's, where a is some other number different from 0 and 1. It encodes each element of the vector in a homomorphic encryption scheme and sends it to all its neighbors. El Gamal encryption is such a protocol. To run this, we either need a third party that manages the keys, or we can run this cooperatively by doing every encryption/decryption through a message exchange that goes through all agents.

In a propagation phase, every node multiplies its (encrypted) vector element-wise with the (encrypted) vectors received from its neighbors, and makes this its new vector. This propagation is repeated at least d times, where d is the length of the longest path between any two nodes. This computes the minimum of all the numbers.

Now every node has to find out if it has the smallest number by comparing its number with the result. A simple version is that all agents cooperatively decrypt the result of the propagation; since no one saw anyone else's number, only the agent whose number is equal to the result of the decryption now knows that it is the leader.

6.2 Other Optimization Algorithms

The optimization algorithm presented in Sections 5.5 and 5.6 is an adaptation of the DPOP algorithm introduced in [2]. DPOP is an algorithm based on dynamic programming, which proved very efficient for solving distributed optimization problems.

However, the present method is by no means restricted to using this particular variant of DPOP for finding the optimal solution. Essentially any other optimization algorithm based on message exchange could be used in place of DPOP. In the following, we exemplify this idea with an algorithm called dAOBB, which is based on branch and bound search.

The dAOBB algorithm works on a pseudotree/DFS ordering as DPOP does. In contrast with DPOP, dAOBB works by performing search on the tree in a top-to-bottom fashion. In this algorithm, EVAL and UTIL messages circulate on the tree, top-down and bottom-up respectively. Agents use EVAL messages to announce their decisions to their subtrees; the agents in the subtrees reply with UTIL messages to inform their parents about the utility they can achieve given these decisions. Upon receiving this utility information via VALUE messages, agents can revise their decisions and try different ones. Like this, agents obtain accurate information about how much utility each one of their decisions can bring to their subtrees (similar to DPOP), given the decisions of their ancestors. The process stops when all agents have decided on their optimal values.

Just as previous sections described in the context of DPOP, dAOBB (or any search algorithm for that matter) can be modified to work in the context of the method we describe here, i.e. with variable code names, and obfuscation/encryption. It is all a matter of replacing the real variables names in the EVAL messages with their corresponding codenames (see Section 5.5.1.2), and adding the random numbers in the VALUE messages (see Section 5.5.1.1). UTIL values can be combined following a similar method as the one used to compute the join of UTIL messages in Section 5.5.2. One could also adapt our method to work with other optimization algorithms like ADOPT or one of its variants, NCBB, and other versions of DPOP.

In general, search algorithms have the advantage that they require only linear memory, as opposed to exponential for DPOP. However, they have two drawbacks: first, they require in general an exponential number of small messages; this produces a large networking overhead which negatively influences performance. Second, the fact that agents do not have a history of their optimal decisions in different contexts of assignments of their ancestors means that it is possible that they have to re-explore the same parts of the search space over and over again, only to re-derive the same results.

The latter shortcoming can be mitigated by using a caching mechanism. A caching mechanism allows agents to remember their decisions they previously took in different contexts of their ancestors' assignments, such that when these contexts appear again in the search process, they can simply retrieve them from the cache instead of performing search again to obtain them. This method has experimentally been proven to greatly increase the efficiency of search.

6.3 Other Encryption/Obfuscation Schemes

The privacy of the agents in our protocol is guaranteed along two dimensions: first, due to the secure leader election (Section 5.4.1), to the anonymous DFS construction (Section 5.4.2), and to the use of codenames (Section 5.5.1.2), agents do not know what other agents are above or below themselves in the tree. Second, due to the value obfuscation scheme (Section 5.5.1.1), agents are unable to learn the valuations of the agents below in the tree, not even in aggregated form. Agents learn however how much their own variable can influence the utility of their subtrees, and about the decisions that have been taken by other agents higher in the DFS tree.

Therefore, the obfuscation scheme described in Section 5.5.1.1 could be regarded as not entirely secure. Nevertheless, we can achieve complete secrecy of utility values by encrypting them using an El Gamal encryption scheme. However, it is no longer possible to use a DFS ordering for optimization; thus the method is less efficient. Instead, agents are ordered linearly. Utility values must be taken from a set of integers in a range of [0 . . . k−1] and are encoded as a vector of k elements. To encode a utility value of i, the i+1-st to k-th elements of the vector are set to 1, while all other elements are set to another number Y.

To obtain this linear ordering, agents first construct an anonymous DFS tree as described in Section 5.4.2. They turn this DFS tree into a circular order. Agents communicate with their successors/predecessors either directly or through the links in the underlying DFS tree when they are not direct neighbours. A constraint is added between the root agent and the last agent in the ordering.

The root starts the UTIL propagation by encoding the utility of each of its values as a vector, as described above. It encrypts each element of the vector using El Gamal encryption with its own key. It sends a message containing this vector for each of its own values to the last agent in the order. It also sends its public El Gamal key to all agents.

Each agent in the order performs the following operations:

For each value in the message it received and each combination of backedge values, it adds its own utility δ by shifting the vector by δ places, and then randomizing all values according to the El Gamal scheme. This is the same propagation as in Section 5.5, except that a linear ordering is used so that messages never need to be joined, and that all utilities are encoded as vectors using the El Gamal scheme.

If it does not have a value, it projects out its own variable by multiplying together element wise all vectors corresponding to the different values of this variable according to the El Gamal multiplication scheme. If it already has a value, it forwards the element corresponding to that value only.

It sends the resulting message to its parent (predecessor) in the ordering.

When the message reaches the root agent, this agent decrypts the utilities for each of its values and picks a value with the highest utility for itself.

In order to assign values to all variables, the protocol iterates with each agent being the root of the tree. The orderings are generated according to the protocol described in Section 5.4.2. Agents that have already been assigned a value behave differently in the propagation and forward directly the UTIL values corresponding to their chosen values without projecting their variables out.

When the protocol has been carried out with each of the agents at the root, all agents have been assigned a value and the problem is solved.

This protocol still leaks some information about utilities as the root agent finds out about the total utilities for each of its values. Provided that there are no ties between optimal values, complete privacy can be provided by the following modification: the agent just below the root agent sends the root agent not the actual UTIL message, but already carries out partial projections of all values whose i-th bit is 1 as well as those whose i-th bit is 0. The root agent can then compare the projections and learn the bits that identify its optimal value, but never finds out the utility values themselves.

6.4 Other Payment Schemes

Section 5.7.2 presents a possible implementation of a protocol to compute the payments that bidders should make to the auctioneers in case they are awarded items. However, the method presented is not limited to this particular payment protocol; computing the payments could be done in a number of other ways, for example according to the division of the surplus by the Shapley values.

### 7 REFERENCES

[1] Rajiv T. Maheswaran, Milind Tambe, Emma Bowring, Jonathan P. Pearce, and Pradeep Varakantham. Taking DCOP to the real world: Efficient complete solutions for distributed multi-event scheduling. In AAMAS-04, 2004.

[2] Adrian Petcu and Boi Faltings. DPOP: A scalable method for multiagent constraint optimization. In Proceedings of the 19th International Joint Conference on Artificial Intelligence, IJCAI-05, pages 266-271, Edinburgh, Scotland, August 2005.

1. Method to allocate inter-dependent resources by a set of at least three participants, this method comprising the steps of:
a. receiving by a first participant a request for a first resource by a third participant, and agreeing between the first participant and the third participant on at least one of a pair of allocation/non-allocation keys for the first resource, the allocation key being related to the allocation of the resource and the non-allocation key being related to the non-allocation of the resource,
b. receiving by a second participant a request for a second resource by the third participant, and agreeing between the second participant and the third participant on at least one of a pair of allocation/non-allocation keys for the second resource, the allocation key being related to the allocation of the resource and the non-allocation key being related to the non-allocation of the resource,
c. the third participant defining at least a first preference value defining his interest in a first combination of allocation or non-allocation of the first and second resources,
d. the third participant obfuscating said first preference value using the two keys corresponding to the first combination of allocation and non-allocation of the first and second resources,
e. transmitting the first obfuscated value directly or indirectly to the second participant,
f. de-obfuscating by the second participant the received preference value using the corresponding allocation/non-allocation keys.

2. Method of claim 1, further comprising the steps of:
a. transmitting directly or indirectly said de-obfuscated first preference value to the first participant,
b. de-obfuscating by the first participant the received preference value using the corresponding allocation/non-allocation keys.

3. Method of claim 2, in which the indirect transmission of said de-obfuscated first preference value further comprises the steps of:
a. receiving by a fourth participant said value, aggregating said value with other preference values,
c. transmitting directly or indirectly by said fourth participant said aggregated value to the first participant.

4. Method of claim 1, further comprising the the second participant using the de-obfuscated first preference value to make a decision to allocate or not allocate the second resource to the third participant.

5. Method of claim 2, further comprising the first participant using the de-obfuscated received preference value or aggregated preference value to make a decision to allocate or not allocate the first resource to the third participant.

6. Method of claim 3, in which the aggregation is obtained by the sum, product, minimum or the maximum of the obfuscated first preference value and at least one other preference value.

7. Method of claim 5, further comprising the steps:
transmitting to the second participant the decision to allocate/not allocate the first resource to the third participant,
deciding by the second participant whether or not to allocate the second resource to the third participant based on the decision made by the first participant and the received preference values.

8. Method of claim 1, in which the definition of the first preference value by the third participant is based on at least one previous decision to allocate or not allocate the first resource to said third participant.

9. Method of claim 1, further comprising the agreement between the first participant and the third participant on a codename defining the allocation/non-allocation of the first resource to the third participant.

10. Method of claim 1, in which the third participant has been allocated the first resource and the first preference value sent to the first participant was defined for the allocation of the first resource to the third participant, this method further comprising the steps of:
requesting by the first participant from the third participant to define his preference value corresponding to the non-allocation of the first resource to the third participant,
defining by the third participant the preference value corresponding to the combination of the non-allocation of the first resource to the third participant and the allocation/non-allocation of the second resource to the third participant, and obfuscating said preference value with the corresponding keys,
transmitting by the third participant said obfuscated preference value directly or indirectly to the second participant,
de-obfuscating by the second participant the received preference value using the corresponding allocation/non-allocation keys,
transmitting by the second participant the resulting de-obfuscated preference value directly or indirectly to the first participant,
de-obfuscating by the first participant the received preference value using the keys corresponding to the non-allocation of the first resource,
using by the first participant the resulting de-obfuscated preference value to define a payment to be requested from the third participant.

11. Method of claim 10, in which the third participant has been allocated the second resource and the first preference value sent to the second participant was defined for the allocation of the second resource to the third participant, this method further comprising the steps of:
requesting by the second participant from the third participant to define his preference value corresponding to the non-allocation of the second resource to the third participant,
defining by the third participant the preference value corresponding to the combination of the non-allocation of the first resource to the third participant and the non-allocation of the second resource to the third participant, and obfuscating said preference value with the corresponding keys,
transmitting by the third participant said obfuscated preference value directly or indirectly to the second participant,
de-obfuscating by the second participant the received preference value using the keys corresponding to the non-allocation of the second resource,
using by the second participant the resulting de-obfuscated preference value to define a payment to be requested from the third participant.

12. Method of claim 1, further comprising the step of establishing a hierarchy among the participants in an anonymous fashion, this establishment comprising the following steps:
a) defining for each participant a participant's identifier,
b) choosing among the participants a preliminary leader
c) constructing a depth-first search arrangement of all the participants, starting from the chosen preliminary leader and using any depth-first traversal method
d) executing by the participants, in depth-first order according to the depth-first arrangement from point c), an encrypted computation that results in each participant computing a function that evaluates to true if the participant is the chosen leader, and to false otherwise
e) propagating a token by the participants, said token propagation being initiated by the leader with the purpose of visiting all participants

13. Method of claim 12, in which the propagation of the token comprises the steps of:
initiating a first token propagation by the chosen leader,
the leader choosing one of its neighbors, and sending the first token to this neighbor,
relaying the first token by each participant when receiving the first token from another participant, to a selected unvisited participant,
replying with a second token when receiving the first token for at least a second time, from another participant different from the participant to which the first token was last sent,
when no other unvisited neighbor participant is found, returning the first token by each participant to the first sender participant that has for the first time sent the first token.

14. Method of claim 12 for sequential decision making, further comprising the steps of:
a) participants taking turns at being the first participant
b) receiving by first participant aggregate preference values as in claim 1
c) using by the first participant the received aggregated preference values to make a decision about allocation/non-allocation of its resources
d) in subsequent runs, participants which have already taken the role of the first participant, aggregate and transmit preference values only taking into account their decisions taken while being the leader.
